(19) United States
(12) Patent Application Publication
(10) Pub. No.: US 2015/0063910 A1
(43) Pub. Date: Mar. 5, 2015

(54) MOORING DEVICE

(71) Applicant: Greenstick Energy LTD, Carnaby, East Yorkshire (GB)

(72) Inventors: Gennady Meltsov, Carnaby, East Yorkshire (GB); David West, Carnaby, East Yorkshire (GB)

(21) Appl. No.: 14/390,782

(22) PCT Filed: Mar. 28, 2013
(86) PCT No.: PCT/GB2013/050817

§ 371 Date: Oct. 4, 2014

(30) Foreign Application Priority Data
Apr. 5, 2012 (GB) 1206197.4

(51) Int. Cl. B63B 21/00; F16L 1/16; F03B 13/22; E02B 8/00; F03B 13/18; F03B 13/26

(52) U.S. Cl. CPC B63B 21/00; F03B 13/1805; F03B 13/262; F03B 13/22; E02B 8/00; F16L 1/16; B63B 2021/003
USPC 405/21; 60/499; 114/230.14; 405/228; 405/158

(57) ABSTRACT

The invention relates to a mooring device that is suitable for use in water. The mooring device includes a pile configured to be embedded in a floor supporting the body of water, at least one arm configured to engage at least one entity; a joint configured to couple the pile and the at least one arm and permit rotation of the at least one arm relative to the pile, and joint locking means configured to lock the joint. The invention may further relate to a method of mounting the mooring device in water, a mooring system including multiple mooring devices and a system including the mooring devices.

### FIELD OF ART

The invention relates to mooring devices that are suitable for use in water. The water may be a moving body of water. The invention further relates to a method of mounting the mooring device in water and to systems that incorporate the mooring device.

### BACKGROUND TO THE INVENTION

A mooring device is a structure for securing (retaining) an object in an aquatic environment.

Mooring devices that are suitable for mounting in a body of water generally include one or more anchors and one or more mooring lines which extend from the anchor to an object.

It has been found that the installation, mounting and/or removal of the anchors and mooring lines can have a detrimental environmental impact on the aquatic environment. For example, the anchors and/or mooring lines may damage the aquatic environment as they are dragged or moved along the floor supporting the body of water.

Certain mooring devices use dead weight or mushroom anchors to permanently anchor the mooring in a body of water. Although these types of anchors are able to provide a sufficient anchoring effect, they are bulky, heavy, expensive to manufacture, difficult to transport and install, are limited for use in only one location and only suitable for mounting on certain types of floor materials.

Certain mooring devices that are suitable for use in water moor objects in a fixed (permanent) position within the aquatic environment. Since these types of mooring devices cannot adjust (adapt) the position of the object in accordance with changing water conditions it has been found that the operation of the object may become compromised as the depth of water varies and the object may become undesirably visible as the water level falls. Moreover, the mooring device may not be able to provide a sufficient mooring effect to hold the object if the direction of flow changes.

### SUMMARY OF THE INVENTION

Embodiments of the invention seek to provide an alternative and improved mooring device and method of mounting a mooring device. Embodiments of the present invention seek to minimise, overcome or avoid at least some of the problems and disadvantages associated with prior art mooring devices. Embodiments of the invention seek to provide a mooring device that has a minimal or limiting environmental effect on the aquatic environment. Embodiments of the invention seek to provide a mooring device that is more compact, lightweight and easier to store, transport and install than conventional mooring devices. Embodiments of the invention seek to provide a mooring device whereby the configuration of the mooring device can change as required. Embodiments of the invention seek to provide a mooring device that is suitable for use in different depths of water and/or different directions of flow. Embodiments of the invention seek to provide a mooring device that is suitable for use in a body of water where the depth and/or the direction of flow may vary over time.

A first aspect of the invention relates to a mooring device that is suitable for use in a body of water. The mooring device comprises:

a pile for embedding in a floor supporting the body of water; at least one arm for engaging at least one entity;
a joint for coupling the pile and the at least one arm and permitting rotation of the at least one arm relative to the pile; and
joint locking means for locking the joint.

The pile is configured to be embedded in the floor so that the mooring device can be mounted in a body of water.

The pile is a lightweight and compact anchor that is easy to store, transport and install and it provides an advantageously high anchoring effect when it is embedded in the floor.

The pile may be permanently embedded in the floor so as to form a permanent mooring device. Alternatively, the pile may be removably embedded in the floor so as to form a temporary mooring device.

The pile may comprise a shaft having a leading end and a trailing end. The pile may comprise a tip formed at the leading end of the shaft. The tip helps the pile to penetrate the floor.

The pile may comprise a screw portion and/or a wing portion. The screw portion and/or wing portion aids the anchoring of the pile in the floor.

The pile may comprise a stop plate arranged a predetermined distance from the leading end. The stop plate helpfully indicates the optimum or maximum depth the pile may be embedded in the floor.

The at least one arm is configured to securely engage the at least one entity so that the at least one entity is moored by the mooring device.

The entity is any article that is suitable for tethering to a mooring device mounted in a body of water. The entity may be an apparatus suitable for use in water. The entity may be a vessel, a floatable body, a structure, a barrier, an energy absorbing device that absorbs energy from the moving water, an energy harnessing device that is driven by the motion of the body of water, a cable/pipe laying apparatus and/or a further mooring device.

The at least one arm may comprise an elongate body having a first end and a second end, whereby the first end is coupled to the pile by the joint.

The at least one arm may comprise engaging means to fasten the at least one entity to the mooring device. The at least one arm may comprise engaging means arranged at the second end of the arm. The at least one arm may comprise engaging means arranged at a location along the length of the elongate body.

The engaging means may permanently or releasably engage the at least one entity. The engaging means may rigidly or freely engage the entity.

The at least one arm may be telescopic. This advantageously allows the length of the at least one arm to be changed as required.

The body one may comprise a plurality of jointed portions. As a result, the shape of the at least one arm may change.

The at least one arm may be floatable (buoyant). As a result, the at least one arm may be suspended in the body of water without sinking and thereby support an entity coupled to the at least one arm. The at least one arm may be sufficiently buoyant such that the at least one arm seeks to extend in a generally upwardly direction from the pile towards the surface of the body of water.

In an embodiment, the mooring device may comprise a first arm and a second arm configured to engage at least one entity. The joint may couple the pile, the first arm and the second arm and it may be configured to permit rotation of the first arm and the second arm with respect to the pile.

The joint couples the pile and the at least one arm and advantageously allows the at least one arm to rotate relative to the pile. The joint may allow the at least one arm to be rotated to a particular orientation. The joint may allow the at least one arm to rotate so that it extends from the pile to a particular height above the floor. The joint may allow the at least one arm to rotate so that it extends from the pile in a particular direction.

When the mooring device is mounted in the body of water, the joint may allow the at least one arm to rotate so that the orientation of the at least one arm can change in accordance with changing water conditions. The joint may allow the at least one arm to be rotated so that the height of the at least one arm above the floor can vary in accordance with the depth of the body of water. The joint may additionally or alternatively allow the at least one arm to be rotated so that the direction in which the at least one arm extends from the pile can vary in accordance with the direction of flow. The joint may allow the at least one arm to rotate in a reciprocating fashion in accordance with the reciprocating (oscillating) motion of the body of water.

The joint allows the at least one arm to rotate in at least one plane.

The joint may be configured to permit rotation of the at least one arm in a vertical plane when the mooring device is mounted in the body of water. Rotation in the vertical plane advantageously allows the height of the at least one arm above the (relative to) the floor to change. Rotation in the vertical plane also allows the direction in which the at least one arm extends from the pile to change between one of two opposing directions.

The joint may permit rotation of the at least one arm in a horizontal plane when the mooring device is mounted in the body of water. Rotation in the horizontal plane advantageously allows the direction in which the arm extends from the pile to change.

The joint may comprise a first portion rotatably mounted or coupled to the second portion, whereby the first portion is arranged in association with the at least one arm and the second portion is arranged in association with the pile. Accordingly, as the first portion rotates with respect to the second portion, the at least one arm rotates with respect to the pile.

The joint may comprise a multi-axle joint that permits rotation of the at least one arm relative to the pile in multiple planes/around multiple axes. For example, the multi-axle joint may comprise a ball and socket joint or a universal joint.

The joint may comprise a single-axle joint that permits rotation of the at least one arm relative to the pile in only one plane. For example, the joint may be a swivel hinge joint or a clevis hinge joint.

The joint may comprise multiple single-axle joints that are configured permit rotation of the at least one arm relative to the pile in multiple planes/around multiple axes. The joint may comprise a first hinge joint that permits rotation of the at least one arm relative to the pile in a first plane (e.g. rotation about an axis that is substantially parallel to the longitudinal axis of the pile) and a second hinge joint that permits rotation of the at least one arm relative to the pile in a second plane (e.g. rotation about an axis that is substantially perpendicular to the longitudinal axis of the pile). For example, the joint may comprise a swivel hinge joint and a clevis hinge joint, whereby when the mooring device is mounted in the body of water, the swivel hinge joint is configured to permit rotation of the at least one arm in a horizontal plane and the clevis hinge pivot is configured to permit rotation of the at least one arm in a vertical plane.

The joint locking means is configured to lock the joint so as to prevent any further rotation of the arm relative to the pile. When the joint is locked, the orientation of the arm is fixed and the mooring device becomes a rigid structure. The combination of the joint and joint locking means advantageously allows the mooring device to be stored, transported, installed and/or used in a rigid state with the arm fixed at a particular orientation. For example, the joint and joint locking means may allow the mooring device to be stored and/or transported in a rigid state with a compact configuration. The joint and joint locking means may allow the mooring device to be installed in a rigid state with a largest/longest possible configuration.

The joint locking means may comprise a plurality of engaging members, whereby the joint is locked when the engaging members engage and the joint is unlocked when at least one of the engaging members disengages from an adjacent engaging member.

As an example, the joint locking means may comprise a first engaging member and a complimentary second engaging member, whereby the joint is locked when the first engaging member and the second engaging member engage and the joint is unlocked when the first engaging member and second engaging member disengage.

The first engaging member and/or second engaging member may be movable between a joint locked position and a joint unlocked position whereby in the joint locked position the first engaging member engages with the second engaging member and in the joint unlocked position the first member and second engaging member are spatially separated.

The first engaging member may move relative to the second engaging member. The second engaging member may move relative to the first engaging member.

The engaging members may comprise any suitable coupling means. The engaging members may have a complimentary castellated configuration. The engaging members may be complimentary male and female coupling means such as a lug and recess/aperture or protrusion and bayonet receptor.

The joint locking means may comprise control means for controlling the position and movement of the first engaging member and/or the second engaging member.

The joint locking means may comprise a pin member and a complimentary cavity, whereby the pin member is movable relative to the cavity between the joint locking position and the joint unlocking position, whereby:

in the joint locking position the pin is configured to extend into the cavity; and
in the joint unlocking position the pin member is retracted (spaced from) from the cavity.

The joint locking means may comprise a first engaging member and a second engaging member whereby:

the first engaging member is movable relative to the second engaging member to the joint locking position where the first engaging member engages with the second engaging member when the arm and pile are substantially coaxial; and
the first engaging member is movable relative to the second engaging member to the joint unlocking position where the first engaging member is spatially arranged from the second engaging member when the arm and pile are substantially non-coaxial.

The joint locking means comprises a first engaging member movably mounted on the arm and a second engaging member mounted on a pile, whereby the first engaging member is movable along the arm between a joint locking position and a joint unlocking position, whereby;

in the joint locking position, the first engaging member is configured to extend along the arm, across the joint and engage with the second engaging member; and
in the joint unlocking position, the first engaging means configured on the arm in spaced relation from the joint and second engaging member.

In an alternative design, the joint locking means may comprise a first engaging member and a second engaging member, whereby the first engaging member is movably mounted on the arm and a second engaging member is mounted on the pile whereby:

the joint coupling the arm and pile is locked when the first engaging member moves along the arm such that it extends across the joint and engages with the second engaging member;
the joint coupling the arm and pile is unlocked when the first member moves along the arm such that it is spatially arranged from the joint and the second engaging member.

A second aspect of the invention relates to a method of mounting a mooring device according to a first aspect of the invention in a body of water, the method comprising;

transporting the mooring device to a desired location;
rotating the arm with respect to the pile until the arm and pile are substantially co-axial;
activating the joint locking means to lock the joint so that the mooring device becomes a rigid structure;
driving the mooring device into the floor supporting the body of water until the pile is embedded in the floor.

The mooring device may be percussively or rotationally driven into the floor. The mooring device is preferably rotationally driven into the floor if the pile comprises a screw portion and/or a wing portion.

The mooring device may be driven into the floor using driving means. Depending on the depth of the water the driving means may be coupled to the pile or the arm during the driving process. The mooring device may be vertically driven or directionally driven into the floor.

Once the mooring device has been mounted in the body of water an entity may be engaged to the arm and the joint locking means may be deactivated to unlock the joint so that the arm is free to rotate with respect to the pile.

The step of engaging the entity and step of deactivating the joint locking means are interchangeable.

A third aspect of the invention relates to a mooring system for use in a body of water comprising multiple mooring devices according to the first aspect of the invention.

The mooring system may comprise two or more mooring devices configured to be coupled together in the body of water.

The mooring system may comprise two or more mooring devices configured to be mounted in spaced relation in the body of water.

A fourth aspect of the invention relates to the use of at least one mooring device according to the first aspect of the invention to moor at least one floatable entity in a body of water.

The floatable entity may be a float, a vessel or any other item that that is suitable for tethering to a mooring device for floatation in the body of water.

A fifth aspect of the invention relates to the use of at least one mooring device according to the first aspect of the invention to moor at least one entity at a predetermined height above a floor supporting a body of water.

A sixth aspect of the invention relates to the use of at least one mooring device according to the first aspect of the invention to moor at least one drilling apparatus in a body of water

A seventh aspect of the invention relates to a drilling system comprising:

at least one drilling apparatus for drilling a floor supporting a body water;
at least one mooring device according to the first aspect of the invention for mooring the drilling apparatus in the body of water.

An eighth aspect of the invention relates to the use of at least one mooring device according to the first aspect of the invention to moor at least one energy absorbing member in a body of water.

A ninth aspect of the invention relates to a breakwater system comprising:

at least one energy absorbing member for absorbing moving water energy and impeding the flow of a moving body of water; and
at least one mooring device according to the first aspect of the invention, for mooring the at least one energy absorbing member in the moving body of water; whereby
the at least one energy absorbing member is coupled to at least one arm of at least one mooring device; and
the joint of the at least one mooring device allows the arm and the at least one energy absorbing member to be orientated in the body of water so that the at least one energy absorbing member is able to absorb moving water energy and impede the flow of the moving body of water.

The energy absorbing member may be a floatable member. The energy absorbing member may be an energy absorbing barrier. The energy absorbing member may have a panel structure, cuboid structure, or triangular prism structure. The energy absorbing member may be movable under the action of the moving body of water. The energy absorbing member may be deformable under the action of the body of moving water. For example, the energy absorbing member may be deformed from a cuboid to a parallelepiped under the action of the body of moving water. The energy absorbing member may be substantially stationary and/or substantially rigid under the action of the body of moving water.

A tenth aspect of the invention relates to the use of at least one mooring device according to the first aspect of the invention to moor at least one aquatic barrier in a body of water so as to form an aquatic wall.

An eleventh aspect of the invention relates to an aquatic wall comprising:

at least one aquatic barrier; and
at least one mooring device according to the first aspect of the invention for mooring the at least one aquatic barrier in a body of water.

A twelfth aspect of the invention relates to the use of at least one mooring device according to the first aspect of the invention to moor a cable/pipe laying device in a body of water.

An thirteenth aspect of the invention relates to an underwater laying system comprising:

at least one underwater laying device; and
at least one mooring device according to the first aspect of the invention for mooring the at least one underwater laying device in a body of water.

The underwater laying device may be configured to lay at least one cable and/or at least one pipe along the floor supporting the body of water.

A fourteenth aspect of the invention relates to the use of at least one mooring device according to the first aspect of the invention to moor at least one energy harnessing device in a body of water.

A fifteenth aspect of the invention relates to an energy harnessing system comprising:

at least one energy harnessing device;
at least one mooring device according to the first aspect of the invention for mooring the least one energy harnessing device in a moving body of water.

The energy harnessing device may comprise a rotatable actuator, a linear actuator, a hydraulic actuator, an electromagnetic actuator or a deformable pumping body actuator driven under the action of the moving body of water. For example, the energy harnessing device may be a turbine comprising at least one rotatable blade that is driven to rotate by the action of the moving body of water. The energy harnessing device may comprise a flywheel, a rack and pinion or a hydraulic piston pump that is driven by the reciprocating action of the arm as a result of the motion of the body of water.

The energy harnessing device preferably comprises a transducer for converting the harnessed energy of the moving body of water to another form of energy, such as electricity.

The energy harnessing system may comprises a floatable body coupled to the at least one arm of the at least one mooring device.

The energy harnessing system may comprise at least one guide member for guiding the moving body of water towards the energy harnessing device

For example, an energy harnessing system may comprise:

a mooring device having a pile, an arm, a joint coupling the pile and arm and permitting rotation of the arm relative to the pile and a joint locking means for preventing rotation of the arm relative to the pile;
a deformable pumping chamber with at least one fluid conduit coupled to the arm;
wherein in use, the pile is embedded in a floor of the body of water and the arm reciprocately drives the deformable chamber of the pump between an expanded condition and a contracted condition as a result of the motion of the body of water such that fluid is pumped into and out of the deformable chamber via the at least one fluid conduit.

For example, an energy harnessing system may comprise:

a mooring device having a pile, an arm, a joint coupling the pile and arm and permitting rotation of the arm relative to the pile and a joint locking means for preventing rotation of the arm relative to the pile;
a flywheel coupled to the arm;
wherein in use, the pile is embedded in a floor of the body of water and flywheel is driven by the reciprocating action of the arm that results from the motion of the body of water.

For example, an energy harnessing system may comprise:

a mooring device having a pile, an arm, a joint coupling the pile and arm and permitting rotation of the arm relative to the pile and a joint locking means for preventing rotation of the arm relative to the pile;
a rack and pinion coupled to the arm;
wherein in use, the pile is embedded in a floor of the body of water and the pinion is driven along the rack by the reciprocating action of the arm that results from the motion of the body of water.

For example, an energy harnessing system may comprise:

a mooring device having a pile, an arm, a joint coupling the pile and arm and permitting rotation of the arm relative to the pile and a joint locking means for preventing rotation of the arm relative to the pile;
a pump having a piston chamber defined by the arm and arranged in fluid communication with at least one fluid conduit and a piston having a piston head which is movably received within the piston chamber;
wherein in use, the pile is embedded in a floor of the body of water and the arm reciprocately drives the piston head within the piston chamber as a result of the motion of the body of water such that fluid is pump into and out of the chamber via the at least one fluid conduit.

### DRAWINGS

For a better understanding of the invention and to show how it may be carried into effect reference shall now be made, by way of example only, to the accompanying drawings in which:—

FIG. 1a depicts a first embodiment of a pile for a mooring device according to a first aspect of the disclosure;

FIG. 1b depicts a second embodiment of a pile for of a mooring device according to a first aspect of the disclosure;

FIG. 1c depicts a top view of a wing portion of the pile shown in FIG. 1b;

FIG. 2a depicts a side view of the first embodiment of a mooring device according to the first aspect of the disclosure, whereby the mooring device is mooring a buoy;

FIG. 2b depicts a front view of a second embodiment of a mooring device according to the first aspect of disclosure; whereby the mooring device is mooring an elongate float;

FIG. 2c depicts a front view of a third embodiment of a mooring device according to the first aspect of the disclosure, whereby the mooring device is mooring an elongate float and a turbine;

FIGS. 3a and 3b depict side views of a first embodiment of a joint for a mooring device according to the disclosure, whereby the joint comprises portions, with a corresponding conical profile, coupled together by a line;

FIG. 4 depicts a cross-sectional view of a second embodiment of a joint for a mooring device according to the disclosure, whereby the joint comprises a ball and socket joint;

FIG. 5 depicts an exploded view of a third embodiment of a joint for a mooring device according to the disclosure, whereby the joint comprises a swivel hinge joint and a clevis hinge joint;

FIG. 6a depicts a cross-sectional view of a first embodiment of a joint locking means for a mooring device according to the disclosure, whereby the joint locking means comprises a movable pin member and cavity arranged to rigidly couple the ball portion and socket and thereby lock the ball and socket joint;

FIG. 6b depicts a top view of the first embodiment of the joint locking means through axis AA whereby the movable pin member is arranged to lock the ball and socket joint;

FIG. 6c depicts a cross-sectional view of the first embodiment of the joint locking means according to the disclosure, whereby the movable pin member is retracted from the cavity so that the ball and socket joint is unlocked and therefore arm, is free to rotate;

FIG. 7 depicts an exploded view of a second embodiment of a joint locking means for a mooring device according to the disclosure, whereby a first castellated member is arranged to slide across the joint and engage with a corresponding second castellated member mounted on the pile;

FIGS. 8a, 8b and 8c depict sequential perspective views of the second embodiment of the joint locking means according to the disclosure as the first castellated member slides across the joint and engages with the corresponding second castellated member;

FIG. 9 depicts a perspective view of a third embodiment of a joint locking means for a mooring device according to the disclosure, whereby a first engaging member that is arranged to slide across the joint and then rotate to securely engage the second engaging member in a bayonet aperture formed in the first engaging member;

FIG. 10 depicts a cross-sectional view of a fourth embodiment of a joint locking means for a mooring device according to the disclosure, whereby a first engaging member is arranged to extend across the joint, retain and engage a corresponding second member in bayonet aperture formed in the first engaging member by rotating the first engaging member;

FIG. 11a depicts a cross-sectional view of a fifth embodiment of a joint locking means for a mooring device according to the disclosure, whereby a control means is activated, moving a second castellated member away from a first castellated member.

FIG. 11b depicts a cross-sectional view of the fifth embodiment of the joint locking means, whereby the control means is deactivated, thereby allowing the second castellated member to engage with the first castellated member.

FIG. 12 depicts a cross-sectional view of a first mooring device and a second mooring device according to the first aspect of the disclosure mounted in a body of water and mooring a boat;

FIG. 13a depicts a cross-sectional view of a first mooring device and a second mooring device according to the first aspect of the disclosure mounted in a body of water to form a rigid mooring structure for mooring a pontoon at a predetermined height above the floor;

FIG. 13b depicts a cross-sectional view of a first mooring device and a second mooring device according to the first aspect of the disclosure mounted in a body of water with a plurality of further structural elements to form a rigid mooring structure for mooring a pontoon at a predetermined height above the floor;

FIG. 14a depicts a side view of a mooring system according to a third aspect of the disclosure mounted in a body of water for supporting a drilling means;

FIG. 14b depicts a top view of the mooring system of FIG. 14a;

FIG. 15 is a cross-sectional view of a first example of a breakwater where a floatable energy absorbing member is mounted in a body of water by a mooring device according to the first aspect of the disclosure;

FIGS. 16a and 16b are a top view and a perspective view of a second example of a breakwater where a barrier member and floatable member are mounted in a body of water by a first mooring device and a second mooring device according to the first aspect of the disclosure;

FIG. 17a is a side view of a third example of a breakwater comprising a deformable cuboid barrier member and floatable member mounted in a body of water by four mooring devices according to the first aspect of the disclosure;

FIG. 17b is a side view of the third example of the breakwater where the barrier has deformed from a cuboid to a parallelepiped under the action of the moving body of water.

FIGS. 18a and 18b are perspective views of a fourth example of a breakwater system where multiple breakwater devices are sequentially mounted along a riverbank;

FIG. 19 is a cross-sectional view of an example of an aquatic wall whereby a plurality of panels are mounted to form a wall in a body of water using a plurality of mooring devices according to the disclosure;

FIG. 20 is a side view of an example of an underwater cable laying system whereby an underwater cable device is mounted in a body of water using a mooring device according to the disclosure;

FIG. 21a is a front view of an example of an energy harnessing system comprising a turbine and floatable member mounted in a body of water using a mounting device as depicted in FIG. 2c;

FIG. 21b is a cross-sectional top-view of a section Z of the energy harnessing system depicted in FIG. 21a where a protruding portion of the turbine slidably mounted in a channel portion of the arm of the mounting device;

FIG. 22 is a perspective view of an example of an energy harnessing system comprising a turbine and a pair of guide members for guiding the flow of water mounted in a body of water using a mounting device according to the disclosure;

FIGS. 23a and 23b are a side view and a front view of a rack and pinion system mounted on a mooring device according to the first aspect of the disclosure;

FIGS. 24a and 24b are a side view and a front view of a rack and pinion system mounted on a mooring device according to the first aspect of the disclosure;

FIG. 25 is a perspective view of a rack and pinion system mounted on a mooring device according to the first aspect of the disclosure;

FIG. 26a is a perspective view of an example of an energy harnessing system comprising a deformable pumping chamber and a hydroelectric transducer mounted in a body of water by four mooring devices according the first aspect of the disclosure;

FIG. 26b is a perspective view of the example of the energy harnessing system of FIG. 26a where the deformable pumping chamber has deformed from a cuboid to a parallelepiped under the action of the moving body of water;

FIG. 27a is a side view of an example of an energy harnessing system comprising a piston pump and a floatable body coupled to the arm of a mooring device according to the disclosure;

FIG. 27b is a cross-sectional view of the piston pump of the energy harnessing system depicted in FIG. 27a.

### DETAILED DESCRIPTION OF THE INVENTION

A first aspect of the invention relates to a mooring device that is suitable for use in a body of water.

A second aspect of the invention relates to a method of mounting the mooring device in a body of water.

A third aspect of the invention relates to a mooring system comprising multiple mooring devices according to the first aspect of the invention.

Further aspects of the invention relate to systems or apparatus that incorporate the mooring device according to the first aspect of the invention.

### A. The Mooring Device

A first aspect of the invention relates to a mooring device that is suitable for use in a body of water.

The body of water may be a movable body of water that moves due to a tide, waves and/or gravity. The body of water may be, for example, a sea, ocean, estuary, river, lake or reservoir. Tides and/or waves cause the level (depth) of the body of water to vary in an oscillating (reciprocating) fashion over time. Tides and/or waves also cause the direction of flow to change over time.

The mooring device is suitable for mooring at least one entity in the aquatic environment associated with the body of water. The entity is any article (object, apparatus, system) that is suitable for tethering to, (engaging) a mooring device mounted in a body of water. The mooring device may moor the entity in a position above the surface of the water, on or near the surface of the water or within the body of water. The entity may be a vessel such as a boat. The entity may be a floatable (buoyant) body such as a buoy or a float. The entity may be a structure (construction) such as a pontoon, frame or barrier. The entity may be an energy absorbing device to absorb the motion of the body of the water. The entity may be an energy harnessing device that is driven by the motion of the body of water. The entity may be a cable laying apparatus. The entity may be a drilling apparatus. So as to form a mooring system comprising multiple mooring devices coupled together, the entity may be a further mooring device.

The mooring device may be a permanent mooring device that is intended to be permanently mounted in the body of water for an unlimited period of time. Alternatively, the mooring device may be a temporary mooring device that may be temporarily mounted in the body of water and then removed after a certain period e.g. when no longer required. The temporary mooring device is reusable, it can be mounted in different locations and has a minimum impact on the aquatic environment

Since the mooring device is suitable for use in a body of water, the mooring device may be used to moor an entity in region or environment that is associated with, adjacent or borders the body of water.

### A(i) The Pile

The mooring device comprises a pile (1). The pile serves as an anchor to at least substantially maintain the location of the mooring device in the body of water.

The pile is configured to be embedded in the floor supporting a body of water. The pile may be configured to be permanently embedded in the floor for an unlimited period of time. Alternatively, the pile may be configured to be removably embedded in the floor so that the mooring device can be temporarily anchored to the floor when it is required and then removed when it is no longer necessary.

The pile may comprise a shaft (1a) having a leading end (1b) and a trailing end (1c).

The longitudinal axis (XX) of the pile extends along the shaft from the leading end to the trailing end. The pile may be embedded in the floor at an angle with respect to a vertical axis. However, to minimise the loads acting on the pile during installation, the pile is preferably embedded in the floor such that the longitudinal axis of the pile extends substantially parallel to a vertical axis.

The pile may comprise a tip (1d) formed at the leading end of the shaft. The tip helps the pile to penetrate the floor.

The shaft may have a substantially uniform diameter or it may taper outwardly from the tip towards the trailing end.

When the pile is embedded in the floor, the leading end of the shaft extends into the floor to a certain depth whilst the portion of the trailing end the shaft protrudes above the floor.

The pile may comprise a stop plate (1e) arranged on the shaft at a predetermined distance from the leading end of the shaft. The stop plate is provided to indicate the optimum or maximum length of shaft that should be embedded in the floor to provide a sufficient anchoring effect. In use, the pile is preferably embedded to a depth such that the stop plate abuts a surface of the floor and a portion of the trailing end of the pile protrudes above the floor. Hence, the joint does not become embedded in the floor.

The pile may comprise a screw portion. The screw portion may comprise a continuous helix (thread) extending along at least a part of the shaft. The screw portion may comprise one or more helical plates (if) sequentially arranged along the shaft. The pile may additionally or alternatively comprise a wing portion. The wing portion may comprise one or more wings. When the wing portion is arranged on the shaft, the one or more wings are configured to project radially from the shaft. The wing portion may be configured to interconnect the piles of two or more mooring devices. The screw portion and/or wing portion aids the anchoring of the pile in the floor. The screw portion and/or wing portion may be securely or removably mounted on the shaft.

The pile may be formed from any material that has sufficient structural integrity to withstand the loads applied as the pile is being installed or when it is embedded. For example, the shaft may be formed from steel, fibreglass or basalt fibre.

The configuration of the pile is dependent on the intended use of the mooring device, the permanence or temporary nature of the mooring device, angle at which the pile is embedded in the floor, the size, shape, weight and type of the entity being moored, the type of floor material, the depth of the body of water, wave height and/or tidal range. The shaft length may range from approximately 1 m to 5 m. The shaft diameter may range from approximately 3 cm to 50 cm. The screw portion diameter may range from 10 cm to 60 cm. The wing portion may extend radially by approximately 10 cm to 60 cm. To provide a sufficient anchoring effect in the floor, the pile may have a minimum shaft length to shaft diameter ratio. When the pile is intended to be embedded in clay, the embedded shaft length is a minimum length of 1 m and the embedded shaft length to screw diameter ratio may be at least 3:1. A pile suitable for being embedded in sands may have a minimum embedded shaft length of 1 m and an embedded shaft length to screw diameter ratio of at least 6:1.

The pile has a high anchoring effect to weight ratio. It also has a high anchoring effect to size ratio. Hence, the pile has a lower weight and is more compact than the anchors of conventional mooring systems. The pile is therefore subsequently cheaper and easier to manufacture, transport and install. The pile also has a limited environmental impact on the aquatic environment.

Due to the superior anchoring effect of the pile, the pile is suitable for anchoring the mooring device in a range of different floor materials, some of which are unsuitable for use with conventional mooring systems. For example, the pile is able to provide sufficient anchorage in seabed soil, clay, sandy loam or sand, silt or mud. The pile is able to provide sufficient anchorage in saturated soils, such as soft water saturated soils.

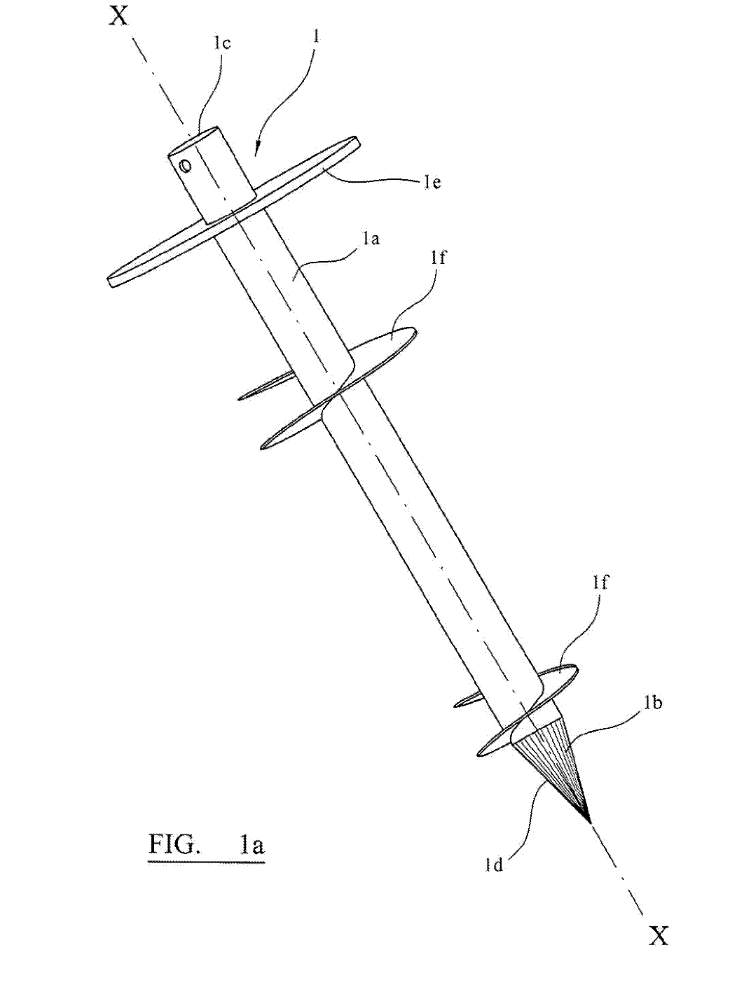

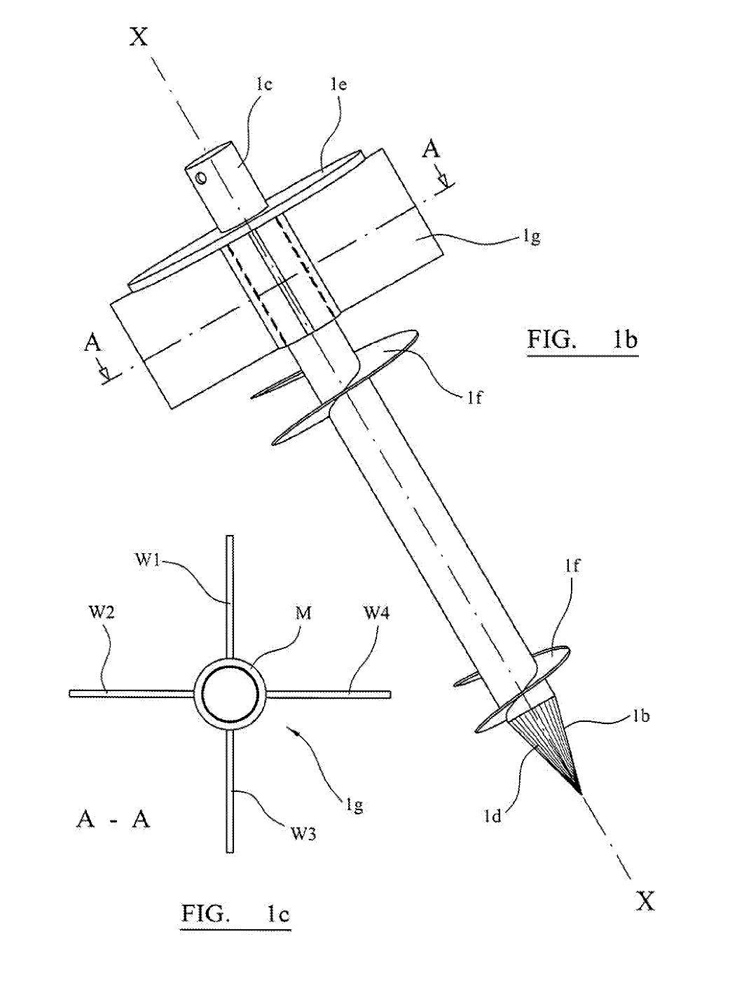

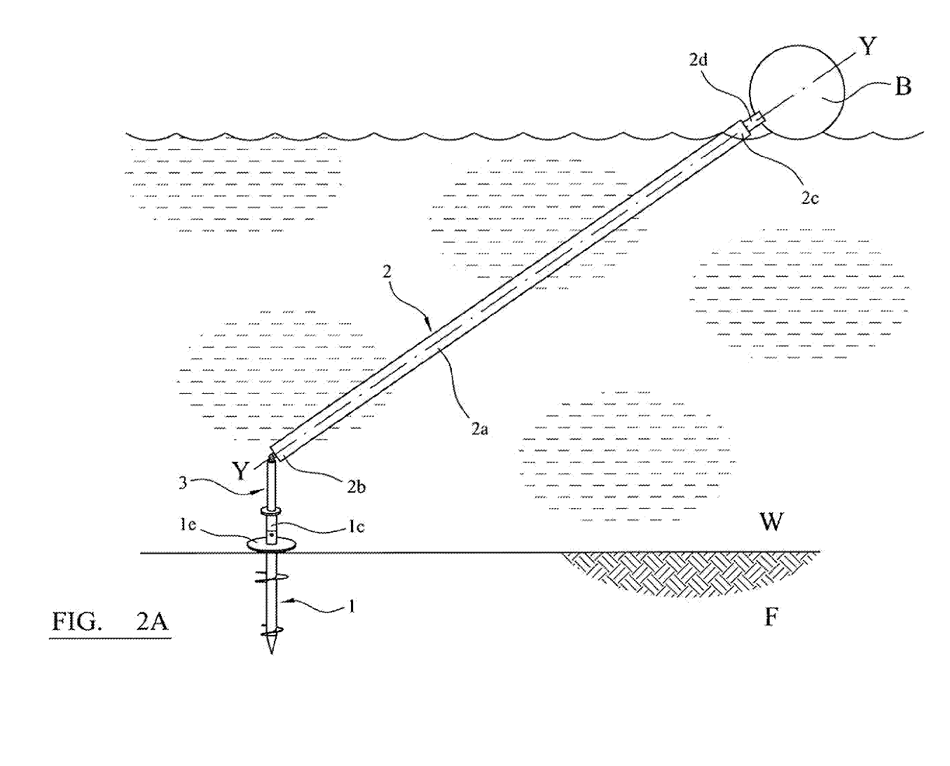

FIG. 1a depicts pile of a first embodiment of the mooring device. The pile (1) comprises a shaft (1a) having a leading end (1b) and a trailing end (1c). The pile is formed from steel, it has a shaft length of approximately 2 m and a uniform shaft diameter of approximately 9 cm. A tip (1d) is formed at the leading end of the shaft. A stop plate (1e) is arranged approximately 1.5 m from the leading end of the shaft. Two helical plates (1f) with a maximum helix diameter of approximately 30 cm are mounted in spaced relation on the shaft between the tip and the stop plate. The longitudinal axis (XX) of the pile extends along the shaft from the leading end to the trailing end.

FIG. 1b depicts a pile of a second embodiment of the mooring device. As with the first embodiment, the pile comprises a shaft (1a) having a leading end (1b) and trailing end (1c). A tip (1d) is formed at the leading end of the shaft. A removable stop plate (1e) is arranged a predetermined distance from the leading end of the shaft. Two helical plates (1f) are mounted in spaced relation on the shaft between the tip and the stop plate. The longitudinal axis (XX) of the pile extends along the shaft from the leading end to the trailing end. A removable wing portion (1g) is arranged on the shaft below the stop plate so as to enhance the anchoring of the trailing end of the shaft. As shown in FIG. 1c, the wing portion comprises four wings (W1, W2, W3, W4) that project radially by approximately 45 cm from a tubular shaped mounting portion (M).

### A(ii) The Arm

The mooring device comprises at least one arm (2). The at least one arm is configured to engage (hold, retain, couple) at least one entity in the aquatic environment.

The at least one arm may comprise a shaft (2a) having a first end (2b) and a second end (2c). The longitudinal axis (YY) of the arm extends along the shaft from the second end to the first end.

The at least one arm may have a substantially linear configuration. Alternatively, the at least one arm may have a non-linear configuration. For example, the at least one arm may be shaped to receive, accommodate or fit flush to the contours of at least part of an entity.

The at least one arm may have a fixed (unchanging) configuration. Alternatively, the shaft may have a variable (adjustable) configuration. For example, the at least one arm may be telescopic so that the length of the arm can change. The length of the at least one arm may be adapted in different depths of water and/or changing depths of water. The at least one telescopic arm may be retracted to a minimum length so that the mooring device can be stored and/or transported more easily. The at least one telescopic arm may be extended to a maximum length so that the mooring device can be mounted more easily. The at least one arm may comprise multiple jointed portions so that the shape of the arm can change. The shape of the at least one arm may be adapted during the storing, transportation, installation, and/or use of the mooring device.

The at least one arm is coupled to the pile by the joint (3). The joint is preferably arranged between the first end of the at least one arm and the trailing end of the pile. Hence, when the mooring device is mounted in a body of water, the at least one arm extends away from the trailing end of the pile through the body of water. If the joint is unlocked, then the at least one arm can be rotated with respect to the pile. If the joint is locked, then the at least one arm has a fixed orientation with respect to the pile and the mooring device has a rigid structure.

Mounting the joint at the bottom end of the at least one arm maximises the length of arm that may be rotated by the motion of the moving body of water and therefore helps to maximise the transfer of energy from the moving body of water to any energy absorption devices or energy conversion devices.

The at least one arm may be floatable (buoyant) in the body of water. As a result, the arm can be suspended in the body of water without sinking. The at least one arm may be sufficiently floatable such that the arm naturally extends from the pile in an upwardly direction from the pile towards the surface of the body of water.

The at least one arm comprises at least one engaging means (2d) to engage (fasten, secure, attach) at least one entity to the mooring device.

The engaging means may be arranged at the second end of the at least one arm to so that at least one entity can be moored to the second end of the at least one arm. This arrangement is suitable, for example, for mooring at least one entity above the surface of the water or for mooring at least one entity that is intended to float on or near the surface of the body of water. Alternatively or additionally, engaging means may be arranged at any location along the length of the at least one arm. This particular arrangement is suitable for mooring at least one entity that is intended to be located within the body of water.

The engaging means may comprise a catch, latch, clamp, clip, mooring line (cable, rope), female/male portion to engage a complimentary male/female portion on the at least one entity or any other suitable mechanical fastening means. For example, the engaging means may comprise a recessed channel formed in the least one arm that is shaped to receive a complimentary protruding portion of the at least one entity. The at least one entity may then be slidably mounted on the at least one arm by sliding the protruding portion along the channel.

The engaging means may be configured to permanently engage the at least one entity. Alternatively, the engaging means may be configured to releasably engage the at least one entity. Hence, this advantageously allows the at least one entity to be released from the mooring device when mooring is no longer required and it allows the mooring device to moor a range of different entities.

The engaging means may be configured to rigidly engage the at least one entity so that the at least one entity is unable to move relative to the arm. Alternatively, the engaging means may be configured to freely engage the at least one entity. For example, if the mooring device is to be incorporated in a tidal or wave energy harnessing system, the engaging means is preferably configured to rigidly engage the at least one entity so as to maximise the transfer of energy from a moving body of water to the energy harnessing system via the at least one arm.

At least a portion of the at least one arm may define a chamber. For example, when the mooring device is used as part of a tidal or wave energy harnessing system, the arm may define a pumping chamber or a turbine chamber.

The configuration of the arm is dependent on the use of the mooring device, the size, shape and weight of the entity being moored, the depth of the body of water, height of waves and/or the tidal range. The arm length may range from 1 m to 10 m.

The elongate body of the arm may have a substantially uniform diameter or it may taper inwardly from the first end towards the second end. The diameter of the arm may range from 5 cm to 30 cm.

The at least one arm may be formed from any material that has sufficient structural integrity to withstand the loads applied by the body of water and/or the at least one entity. For example, the body of the at least one arm may comprise steel, fibreglass or basalt fibre. The body of the at least arm may be hollow so as to regulate the density of the arm such that the arm can float within the body of water.

The mooring device may comprise multiple arms optionally comprising the features as described above. The multiple arms may be configured to engage the same or different entities. The multiple arms may be coupled to the pile via the joint.

A mooring device with multiple arms may further comprise arm locking means to releaseably lock the arms together. When locked together, the arms combine to form a single arm member that allows the mooring device to be transported and/or installed more easily. The arm locking means may comprise a clamp, clip or any suitable means for fastening the arms together.

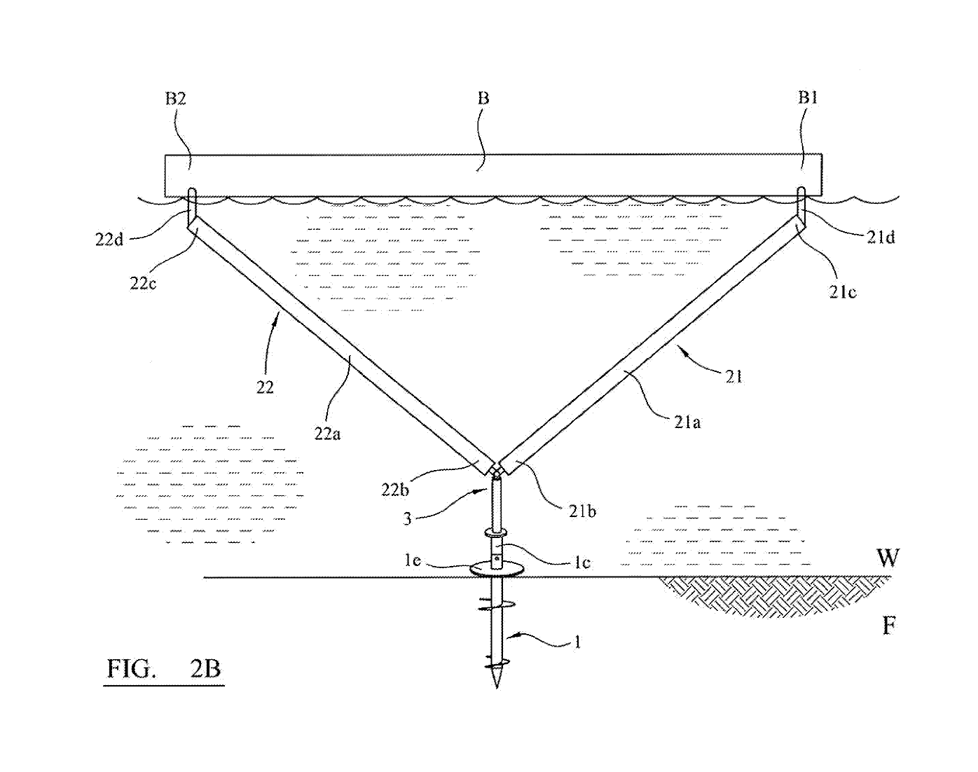

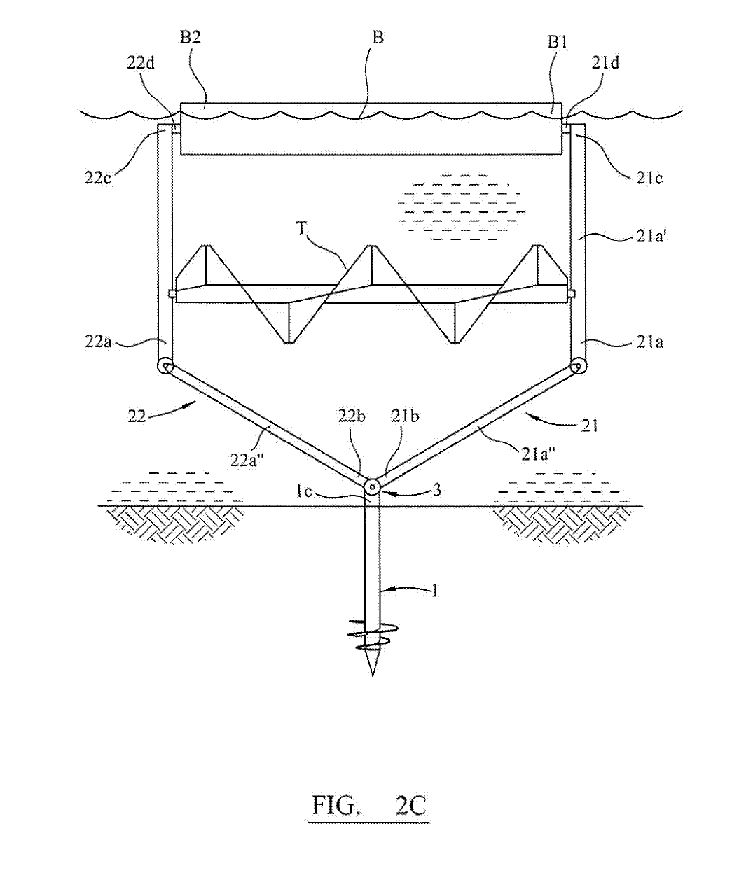

FIG. 2a depicts a first embodiment of a mooring device (M) mounted in a body of water (W). The mooring device comprises a pile (1) as depicted in FIG. 1, an arm (2), a joint (3) and joint locking means (not shown). The pile is vertically embedded into the floor (F) to a depth where the stop plate (1e) abuts the surface of the floor and the trailing end (1c) protrudes above the floor. The arm (2) comprises a shaft (2a) having a first end (2b) and a second end (2c). The longitudinal axis (YY) of the arm extends along the shaft from the first end to the second end. The arm further comprises an engaging means in the form of a catch (2d). In this embodiment, the catch is arranged at the second end of the shaft to secure a buoy (B) floating on the surface of the water.

FIG. 2b depicts a second embodiment of a mooring device mounted in a body of water (F). The mooring device comprises a pile (1) as depicted in FIG. 1, a first arm (21), a second arm (22), a joint (3) and joint locking means (not shown). The mooring device moors an elongate floatable body (B) that floats on the surface of the water and extends between the first arm and the second arm. The pile is vertically embedded into the floor (F) to a depth where the stop plate (1e) abuts the surface of the floor and the trailing end (1c) protrudes above the floor. The first arm and second arm have an identical configuration. The first arm comprises a shaft (21a) having a first end (21b) and a second end (21c) and also a catch (21d) arranged at the second end for coupling a first end (B1) of an elongate floatable body. Likewise, the second arm comprises a shaft (22a) having a first end (22b) and second end (22c) and a catch (22d) arranged at the second end to couple the second end (B2) of the floatable body. The first ends of both the first arm and second arm are coupled to the pile by the joint. FIG. 2b depicts the arms in an unlocked arrangement. However, the arms may be locked together using a clamp (not shown), thereby forming a single, elongate arm member.

FIG. 2c depicts a third embodiment of a mooring device mounted in a body of water (F). As with the second embodiment, the mooring device depicted in FIG. 2c comprises a pile (1), a first arm (21), a second arm (22), a joint (3) and a joint locking means (not shown). In this embodiment, the mooring device moors a turbine (T) that is arranged in the body of water between the first arm and the second arm. To ensure the first arm and second arm extend in an upwardly direction in the body of water, the mooring device also moors an elongate floatable body (B) that floats on the surface of the water and extends between the first arm and the second arm. The floatable body is optional depending on the floatability of the arms. The pile is vertically embedded in the floor (F) to a depth where the stop plate (1e) abuts the surface of the floor and a trailing end (1c) protrudes above the floor. The first and second arms have an identical configuration. The first arm comprises a shaft (21a) having a first end (21b), a second end (21c) and a catch (21d) arranged at the second end for coupling a first end (B1) of an elongate floatable body. The shaft of the first arm is formed from a first portion (21a′) jointed (interconnected) to a second portion (21a″), whereby the first portion is movable with respect to the second portion The second arm comprises a shaft (22a) having a first end (22b) and second end (22c) and a catch (22d) arranged at the second end to couple the second end (B2) of the floatable body. The shaft of the second arm is formed from a first portion (22a′) jointed (interconnected) to a second portion (22a″), whereby the first portion is movable with respect to the second portion. FIG. 2c depicts how the first portions of the respective arms are movable to a parallel configuration so that the turbine can be mounted on the arms. In this embodiment, the turbine is slidably mounted on the first portions of the arms by sliding a protruding portion arranged at each end of the turbine along a corresponding channel formed in respective first portions of the arms. The first ends of both the first arm and second arm are coupled to the pile by the joint. To provide an alternative arrangement, the arms may be locked together using a clamp (not shown), thereby forming a single, rigid, elongate arm member.

### A(iii) The Joint

The mooring device comprises a joint (3). The joint is configured to couple the pile and the at least one arm and permit rotation of the at least arm with respect to the pile.

If the mooring device comprises multiple arms, then the joint may couple the pile and multiple arms and permit rotation between the arms and the pile.

The joint allows the at least one arm to rotate with respect to the pile so that the orientation of the at least one arm, and therefore the configuration of the mooring device, can change.

The at least one arm may be manually rotated with respect to the pile by a user. When the mooring device is mounted in a body of water, the at least one arm may be driven to rotate by forces of the body of water acting on the at least one arm.

The joint may allow the at least one arm to rotate to a particular orientation. For example, when the mooring device is mounted in the body of water, the joint may allow the at least one arm to rotate until it is extends from the pile to a particular height above the floor. The joint may allow the at least one arm to rotate until it extends from the pile in a particular direction. When removed from the body of water, the joint may allow the at least one arm to be rotated until the at least one arm is arranged adjacent and extends parallel to the pile so that the mooring device has an advantageously compact configuration. The joint may allow the at least one arm to be rotated until the at least one arm and pile are co-axial. If the at least one arm is buoyant, the joint may allow the at least one arm to rotate so that it extends from the pile in an upwardly direction towards the surface of the body of water. The joint may allow the at least one arm to rotate until the at least one arm has an orientation where it can engage the entity located in or above the body of water. The joint may allow the at least one arm to rotate so that at least one entity coupled to the arm can have a particular orientation in the body of water. For example, the joint may allow the at least one arm to rotate so the at least one entity can be arranged at a particular height above the floor, at or near the surface of the body of water or within the body of water. The joint may allow the at least one arm to rotate so that the entity is arranged or can extend in a particular direction relative to the flow of the body of water.

When the mooring device is mounted in a body of water, the joint may allow the at least one arm to rotate under the action of the body of water so that the orientation of the arm can change in accordance with the water conditions. The joint may allow the arm to rotate so that the height to which the arm extends may vary in accordance with the depth of the body of water. The joint may allow the arm to rotate so that the direction in which the arm extends from the pile may vary in accordance with the direction of flow.

The joint allows the at least one arm to rotate in at least one plane.

The joint may be configured to allow the at least one arm to rotate in a plane that is parallel to the longitudinal axis of the pile (around an axis that is perpendicular to the longitudinal axis). Additionally or alternatively, the joint may be configured to allow the at least one arm to rotate in a plane that is perpendicular to the longitudinal axis of the pile (around an axis that is parallel to the longitudinal axis).

For example, when the mooring device is mounted in the body of water, the joint may allow the at least one arm to rotate in a vertical plane (around a horizontal axis). Rotation in the vertical plane allows the height of the at least one arm to change. The at least one arm can be driven to rotate in the vertical plane when it is subject to the vertical forces of the body of water. Hence, the joint allows the height of the at least one arm to be adjusted in accordance with the depth of the water. If the mooring device is mounted in a body of water that is moving due to tide and/or wave motion, then the at least one arm will rotate in the vertical plane so that the height of the arm varies in a reciprocating fashion as the depth of the body of water oscillates. Rotation in the vertical plane may also allow the direction of the at least one arm to change between one of two opposing directions.

For example, the joint may be additionally or alternatively configured to allow the at least one arm to rotate in a horizontal plane (around a vertical axis). This type of joint allows the at least one arm to be rotated so that the direction in which the arm extends from the pile can vary. If the mooring device is mounted in a moving body of water then the joint may allow the arm to rotate under the horizontal motion of the body of water so that the at least one arm extends from the pile in the direction of flow. Hence, the joint allows the direction of the at least one arm to be adjusted in accordance with the direction of flow.

The joints of the mooring devices depicted in FIGS. 2a, and 2b allow the arms of the mooring devices to rotate in a vertical plane so that the buoy/floatable member (B) can be moored on or near the surface of the body of water. To help maintain the floating orientation of the buoy/floatable member during use, the joints of the mooring devices depicted in FIGS. 2a and 2b allow the arms to rotate so that the height of the arms can be is adjusted in accordance with the depth of the body of water.

The joint of the mooring device depicted in FIG. 2c allows the arms of the mooring device to rotate in vertical plane so that the floatable member (B) can be moored on or near the surface of the body of water and the turbine (T) can be moored in a central portion (mid height) of the body of water where the driving force of the body of water is typically optimised. So as to optimise the driving force effect on the turbine, the joint also allows the arms of the mooring device to rotate in a horizontal plane so that the arms can extend from the pile in the direction and flow and the longitudinal axis of the turbine shaft can extend in a direction that is perpendicular to the direction of the flow. To help maintain the orientation of the floatable member and turbine during use, the joint of the mooring device depicted in FIG. 2c allows the arms to rotate so that the height of the arms can be adjusted in accordance with the depth of the body of water and/or the direction of the arm can be adjusted in accordance with the direction of flow.

The joint is arranged between the pile and the at least one arm, preferably between the trailing end of the pile and the first end of the arm. For example, when the mooring device is used as part of a tidal or wave energy conversion system, the joint is arranged between the trailing end of the pile and the first of the arm so as to optimise the variable height of the arm as the arm rotates in a vertical plane.

The joint may allow for the rotation of the at least one arm around a single axis with respect to the pile. For example, the joint may be a hinge joint that allows for rotation in only one plane such as a swivel hinge joint or a clevis hinge joint. The hinge joint may allow for rotation of the at least one arm in a vertical plane or a horizontal plane when the mooring device is mounted in the body of water. The joint may allow for rotation of the at least one arm around multiple axes with respect to the pile. For example, the joint may be a multi-axial joint such as a universal joint or a ball and socket joint. The joint may comprise a first hinge joint that permits rotation of the at least one arm in a first plane and a second joint that permits rotation of the at least one arm in a second plane.

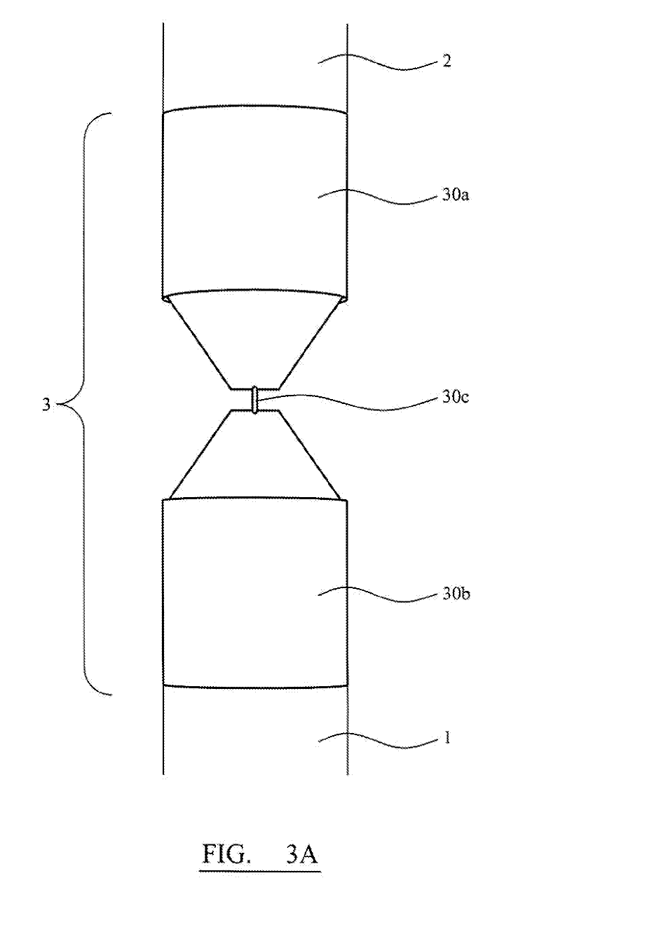

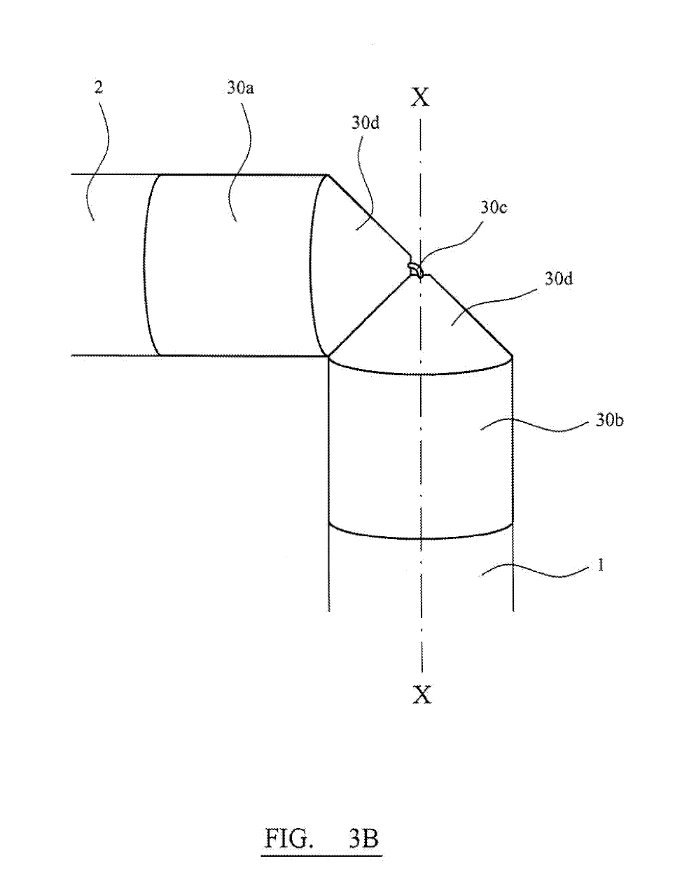

In its simplest form the joint may comprise a cable, rope, chain or any other suitable line extending between the at least one arm and the pile. When the pile is embedded in the floor, this type of joint allows the at least one arm to rotate around multiple axes with respect to the pile. FIGS. 3a and 3b depict a first embodiment of a joint (3) comprising a first portion (30a) coupled to the arm (2), a second portion (30b) coupled to the pile (1), a flexible line (30c) extending between the first portion and the second portion. The flexible line couples the first portion and the second portion so as to permit rotation of the arm relative to the pile. The flexible line allows the arm to freely rotate (up to 360°) about an axis that is parallel to the longitudinal axis of the pile (in the horizontal plane). The first portion and second portion have corresponding conical surfaces (30d). The corresponding conical surfaces limit the rotation of the arm about an axis that is perpendicular to the longitudinal axis of the pile (in the vertical plane). As shown in FIG. 3b, the arm may rotate in the vertical plane until he corresponding conical surfaces of the first portion and second portion mate (abut) and the arm extends in a direction that is substantially perpendicular to the longitudinal axis of the pile (XX). When mating, the corresponding conical surfaces allow the first portion (arm) to rotate smoothly with respect second portion (pile) in a horizontal plane.

In an alternative design, the joint may comprise a first portion coupled to the at least one arm and a second portion coupled to the pile, whereby the first portion is configured to be rotatably mounted with respect to the second portion to permit rotation of the arm relative to the pile.

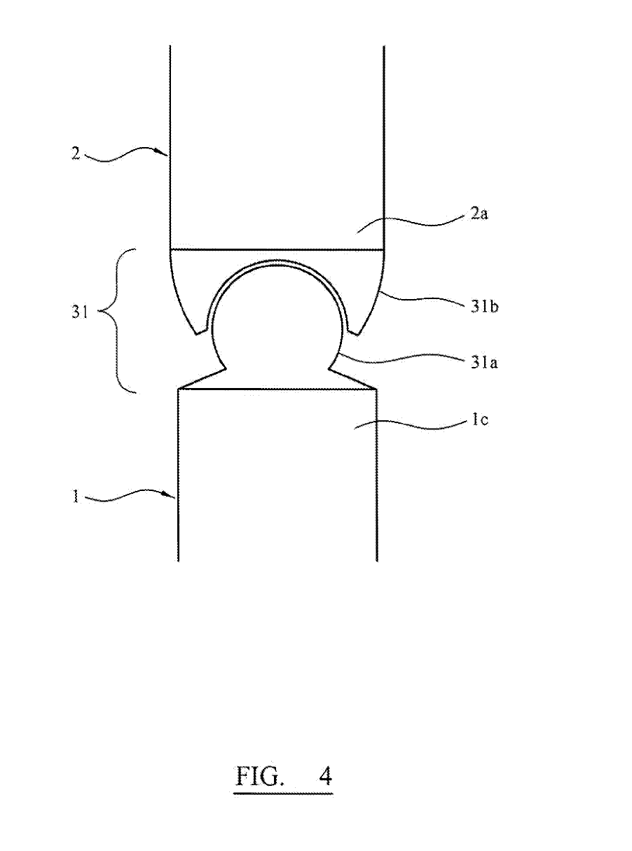

FIG. 4 depicts a cross-sectional view of a second embodiment of a ball and socket joint (31) that is configured to couple the pile (1) and arm (2) and allow for free rotation of the arm in any direction relative to the pile. The ball and socket joint comprises a generally ball shaped head (31a) fitted within a complimentary cavity (31b), whereby the ball shaped head portion is arranged at the trailing end of the pile (1c) and the complimentary cavity portion (3b) is arranged at the first end of the arm (2b). The ball and socket joint permits rotation of the arm in at least the vertical plane and the horizontal plane. Hence, the ball and socket joint allows the height of the arm to vary in accordance with the depth of the body of water and allows the direction of the arm to vary in accordance with the direction of flow.

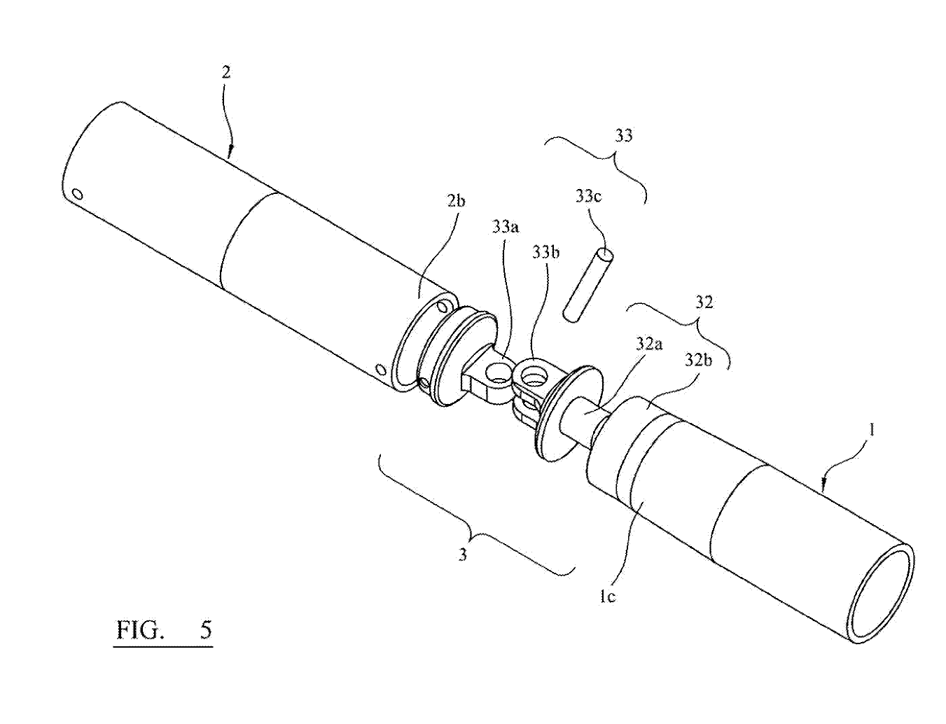

FIG. 5 depicts an exploded view of a third embodiment of a joint (3) comprising a swivel hinge joint (32) and a clevis hinge joint (33). The swivel hinge joint (32) comprises a shaft portion (32a) that is indirectly coupled to the arm (2) and a recess portion (32b) that is directly coupled the trailing end of the pile (1c) whereby the shaft portion is rotatably mounted in the recess portion to allow for rotation of the arm around the shaft axis. The clevis hinge joint (33) comprises a tang portion (33a) that is directly coupled to the first end of the arm (2a) and a fork portion (33b) that is indirectly coupled to the pile, whereby the tang portion is rotatably coupled to the fork portion by a clevis pin (33c) to allow for rotation of the arm around the clevis pin axis which is perpendicular to the longitudinal axis of the pile. Hence, if the pile is vertically embedded in the floor, the swivel hinge joint allows the arm to rotate with respect to the pile around a vertical axis (in a horizontal plane) and the clevis hinge joint allows the arm to rotate with respect to the pile around a horizontal axis. Accordingly, the swivel hinge joint allows the direction of the arm to vary in accordance with the direction of flow and the clevis hinge pivot allows the height of the arm to vary in accordance with the depth of the body of water.

### A(iv) The Joint Locking Means

The mooring device comprises a joint locking means (4). The joint locking means is configured to lock the joint so that the at least one arm is unable to rotate relative to the pile.

When the joint is locked, the at least one arm has a fixed orientation and the mooring device is a rigid structure.

The combination of the joint and joint locking means advantageously allows the mooring device to be stored, transported and/or used in a rigid state with the at least one arm arranged at a particular orientation. For example, the joint locking means may be activated to lock the joint after the at least one arm has been rotated to extend parallel to the pile so that the mooring device can be stored and/or transported in a rigid state with a compact configuration. The locking means may be activated to lock the joint when the at least one arm and pile are co-axial so that the mooring device can be installed in the body of water in a rigid state. Since the overall length of the mooring device is now maximised, the mooring device can also be installed in a deeper body of water.

The joint locking means may comprise any suitable means for locking the joint. The joint locking means may comprise mechanical, electronic and/or electromagnetic locking means. The joint locking means may be manually operable so that a user can control when the joint is locked or unlocked. The joint locking means may be remotely operable. The joint locking means may be operable under the rotating action of the arm. The joint locking means may be operable under the action of gravity.

If the joint comprises a chain extending between the first portion and second portion then the joint may become locked by rotating the arm relative to the pile about the longitudinal axis of the pile until the chain links are sufficiently rotated with respect to one another such that they become interlocked. When the chain links are interlocked, the arm is unable to further rotate relative to the pile and the mooring device is a rigid structure.

In an alternative design, the joint locking means may comprise at plurality of complimentary engaging members, whereby the joint is locked when the complimentary engaging members engage and the joint is unlocked when at least one of the engaging members disengages from an adjacent engaging member.

The joint locking means may comprise a first engaging member and a complimentary second engaging member movable between a joint locked position and a joint unlocked position. In the joint locked position the first engaging member and the second engaging member are engaged and the joint between the arm and the pile is locked. In the joint unlocked position the first member and second engaging member are spatially separated and the joint is unlocked.

The first engaging member may be arranged in association with the at least one arm and the second engaging member arranged in association with the pile.

The first engaging member and second engaging member may comprise any suitable coupling means. The first engaging member and second engaging member may be complimentary engaging means with an interconnecting castellated configuration. The first engaging member and second engaging member may be complimentary male and female engaging means such as a protrusion and recess.

The first engaging member may be configured to move relative to the second engaging member. Additionally or alternatively, the second engaging member may be configured to move relative to the first engaging member.

The first engaging member and/or second engaging member may be movable between the joint locking position and a joint unlocking position by a sliding or rotating action.

The joint locking means may comprise control means to control the position and movement of the first engaging member and/or the second engaging member. The control means may restrict (limit) the movement of the first engaging member and/or the second engaging member.

The engaging means may require a twisting action to securely engage.

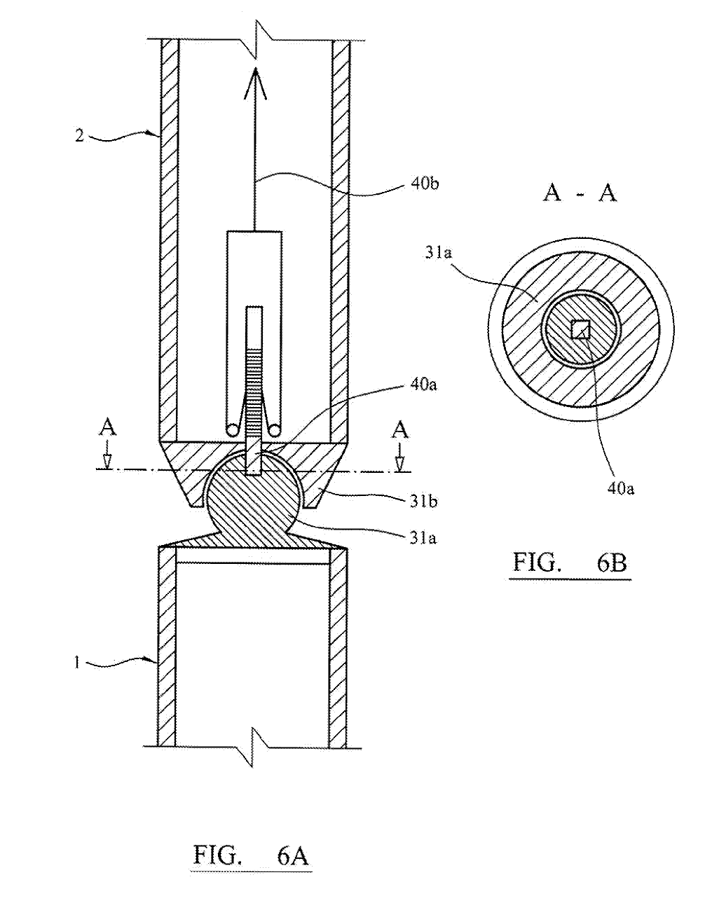

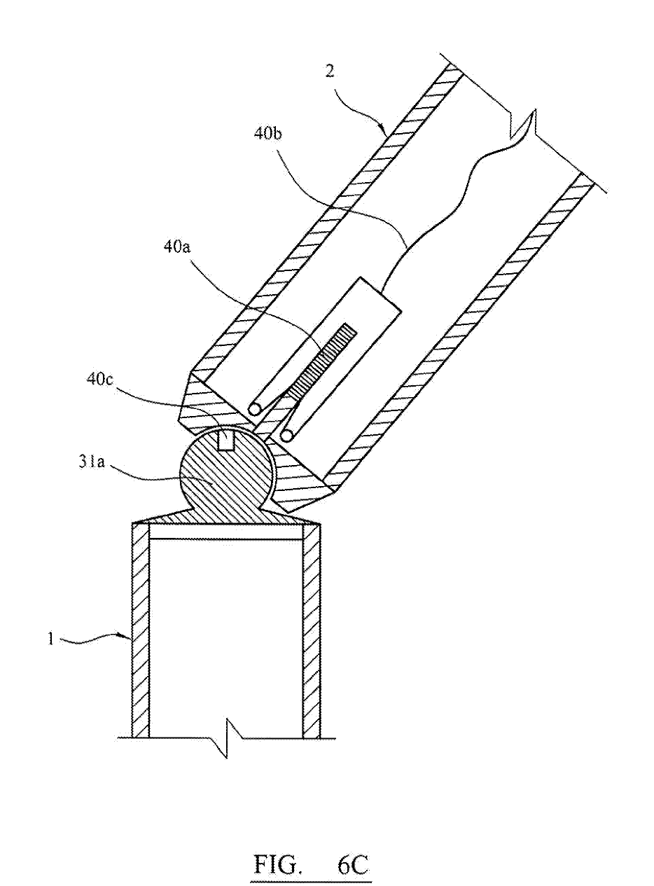

FIGS. 6a to 6c depict an embodiment of a joint locking means that comprise a first engaging member in the form of a movable pin member (40a) and a second engaging member in the form of a complimentary recess (40c). The joint is locked when the pin member extends within the recess. The joint is unlocked when the pin member is retracted from the recess. This particular embodiment of the joint locking means (4) is suitable for locking a ball and socket joint as previously depicted in FIG. 3. The pin member (40a) is spring mounted in the socket portion (31b) of the joint. The recess (40c) is formed in the ball portion (31a) of the joint. The position of the pin member is controlled by a manually operable cable (40b). As shown in FIGS. 6a and 6b, the joint becomes locked when the cable is placed under sufficient tension such that the spring mounted pin member extends (protrudes) from the socket portion (31b) and into a recess (40c) formed the ball portion (31a). Hence, when the joint becomes locked the arm is unable to rotate relative to the pile. As shown in FIG. 6c, the pin member moves to a retracted position and no longer extends beyond the socket portion when the cable is released. Hence, the joint becomes unlocked and the socket portion coupled to the arm is free to rotate with respect ball portion coupled to the pile. It will be understood that the configuration of the recess in the ball portion will determine the orientation of the arm in the locked state. In the embodiment depicted in FIGS. 6a to 6c, the recess is formed centrally at the top of the ball portion and so the joint can only be locked when the arm is arranged co-axial to the pile and the pin member extends into the cavity between the between the socket portion and ball portion.

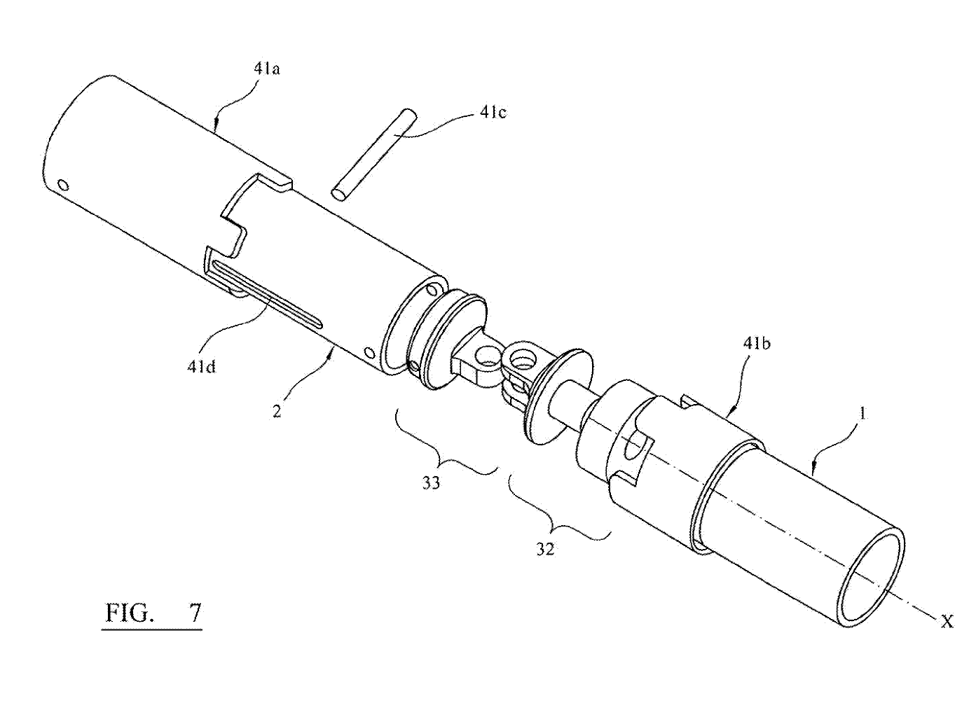

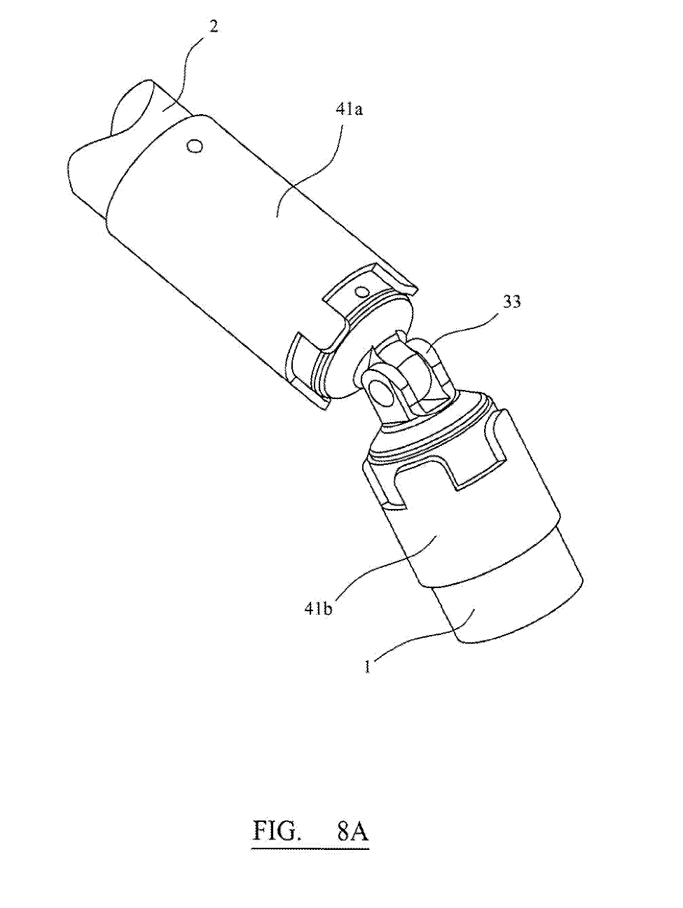

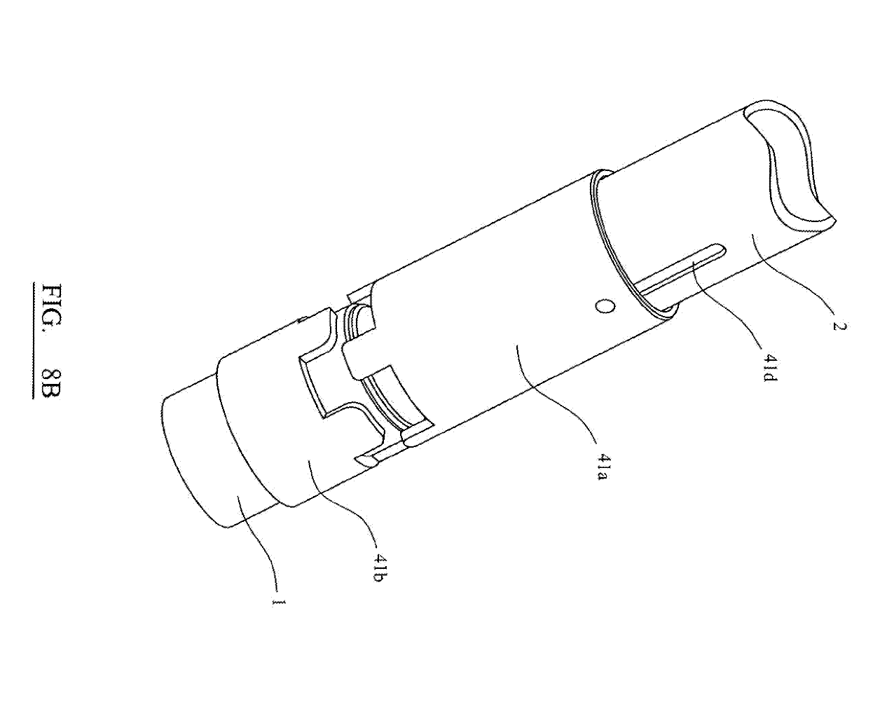

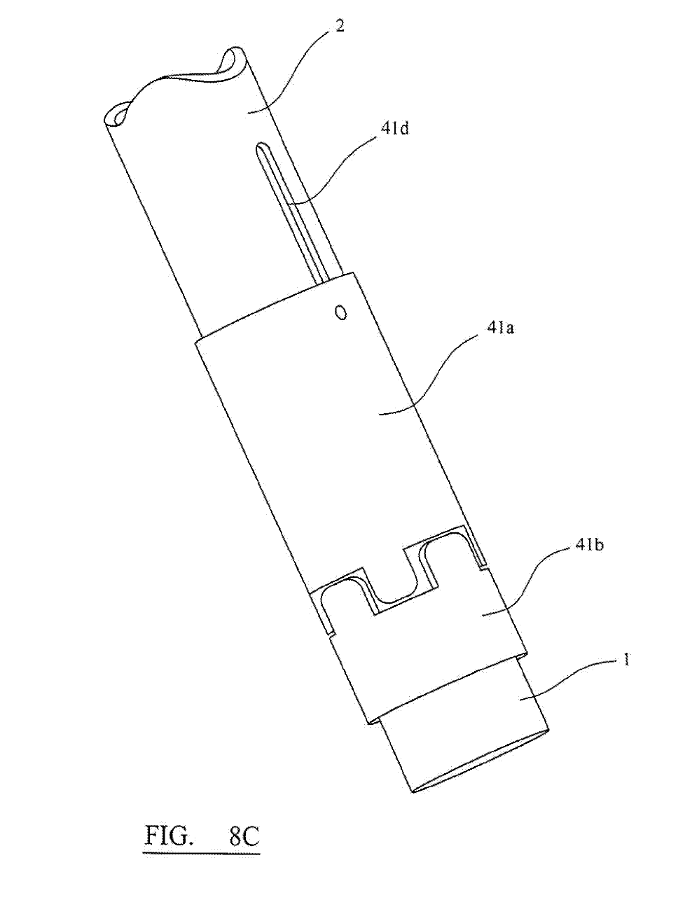

FIGS. 7, 8a, 8b and 8c depict a second embodiment of a joint locking means that comprises a slidable first engaging member and a stationary second engaging member. FIG. 7 depicts an exploded view of a pile (1), an arm (2), a joint (31, 32) as previously depicted in FIG. 5 and a joint locking means. The joint locking means comprises a first engaging member (41a) circumferentially mounted on the arm and a second engaging member (41b) circumferentially mounted on the pile. The first engaging member is a slidable sleeve with a castellated edge facing the second engaging member. The second engaging member is a stationary sleeve with a corresponding castellated edge facing the first engaging member. The castellated edges of the first engaging member and second engaging member each have a plurality of protrusions and indentations. The first engaging member is mounted on the arm such that it can slide along the arm towards or away from the second engaging member as required. The joint becomes locked when the first engaging member slides along the arm in a direction towards the second engaging member, across the joint and the corresponding castellated edges of the first engaging member and second engaging member securely engage (interlock). Due to the configuration of the mating castellated edges, the joint locking means prevents rotation of the swivel hinge joint (32) around an axis that is parallel to the longitudinal axis (XX) of the pile and also prevents rotation of the clevis hinge joint (33) around an axis that is perpendicular to the longitudinal axis of pile. Likewise, the joint becomes unlocked when the first engaging means slides along the arm in a direction away from the second engaging member such that the corresponding castellated edges of the first engaging means and second engaging means are arranged in spaced relation and the first engaging means no longer extends across the joint. As shown in FIGS. 8a to 8c the first engaging member may slide along the arm towards the second engaging member under the force of gravity as the arm (2) is rotated upwardly and it becomes coaxial with the pile. When the arm is substantially coaxial with the pile, the first engaging member extends across the joint and the corresponding castellated edges securely engage. The maximum distance traveled by the first engaging member along the arm may be limited by coupling the first engaging member to a pin (41c) that is configured to travel along an elongate aperture (41d) formed in the arm. In this embodiment, the joint locking means may be activated to lock the joint if the arm is manually rotated to the substantially coaxial position. Alternatively, joint locking means may be activated to lock the joint if the arm is rotated to the substantially coaxial position under the action of a moving body of water. The joint locking means may further comprise manually operable control means to control the position and movement of the first engaging member so as to lock and/or unlock the joint as required.

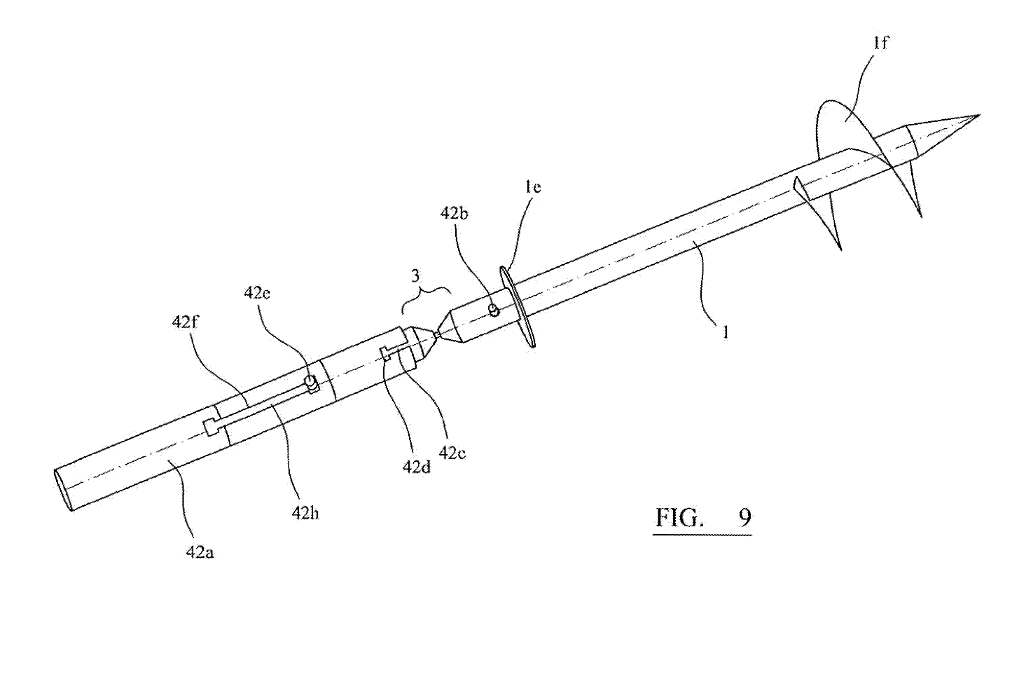

FIG. 9 depicts a third embodiment of a joint locking means having a bayonet twist locking configuration. The first engaging member comprises a sleeve (42a) slidably mounted on the arm (2). A T-shaped or L-shaped aperture is formed in the sleeve with a channel region (42c) and an offset region (42d). The second engaging member is a lug (42b) extending outwardly from the pile. The joint is locked by sliding the sleeve across the joint (3) towards the pile so that the lug is guided along the channel region of the aperture to the offset region and then twisting the sleeve to that the lug is securely retained in the offset region of the aperture. The joint locking means further comprises control means for controlling the sliding motion of the sleeve. In this embodiment, the control means comprises a pin (42e) that is configured to travel along an I-shaped, T-shaped or L-shaped elongate aperture (42f) formed in the sleeve. The elongate aperture comprises a channel region (42g) and offset regions (42h) at one or both ends. Due to the control means, the sleeve may only slide along the arm towards the lug on the pile when the pin is released from an offset region and it may is free to travel along the channel region of the elongate aperture.

FIG. 10, depicts a fourth embodiment of a joint locking means that has a similar bayonet twist locking configuration to the joint locking means in FIG. 9. However, in this embodiment, the first engaging means is a sleeve (43a) that is rotationally mounted on the arm. Hence, the joint is locked by applying a rotating action to move the sleeve across the joint (3) and towards the pile (1) so that the lug (43b) is guided along the channel region (43c) to the offset region (43d) and then applying a further rotating action so that the lug becomes securely engaged in the offset region.

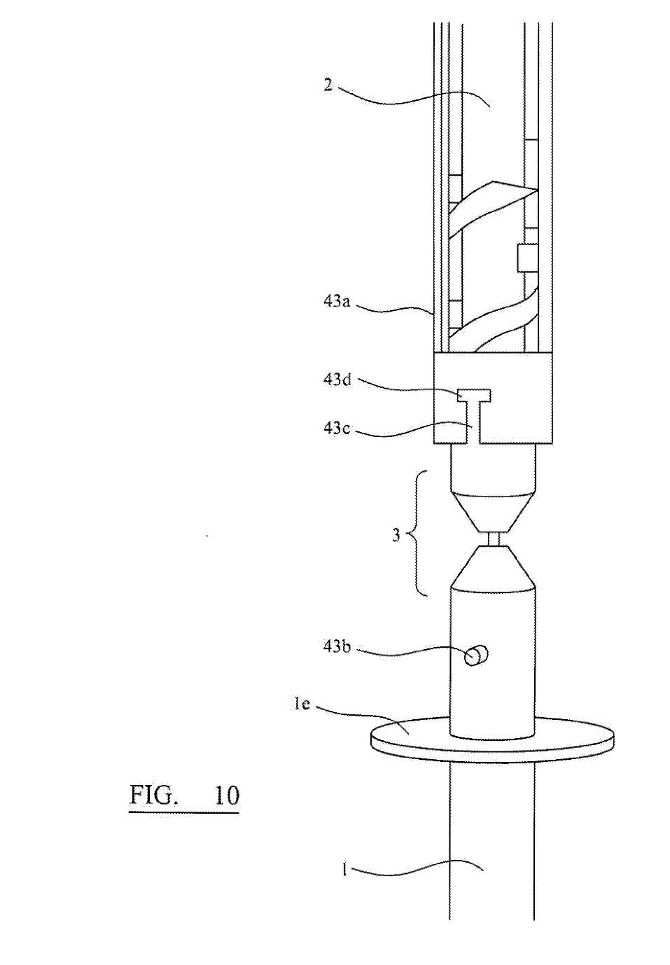

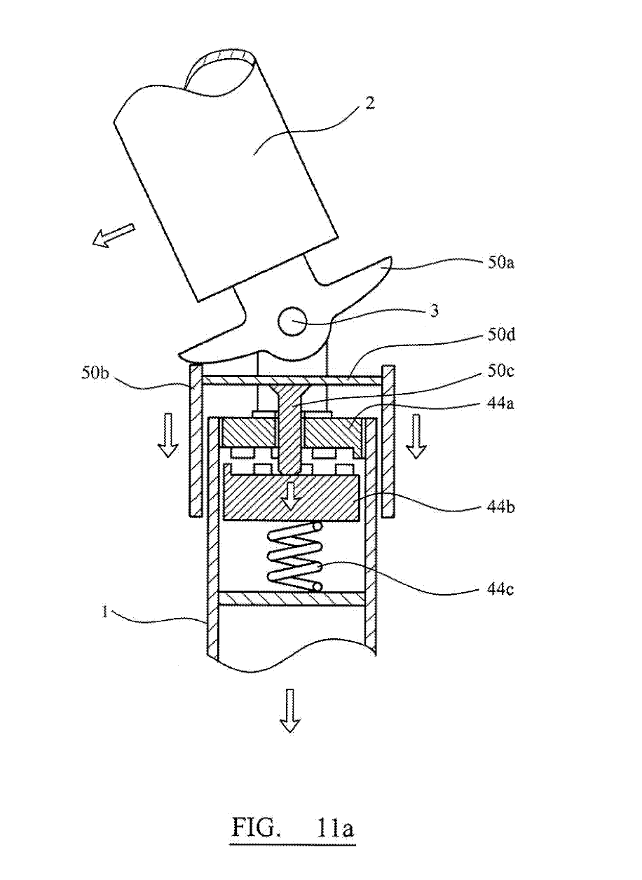

FIGS. 11a and 11b depict a fifth embodiment of a joint locking means that is operable under the rotation of the arm (2). In this embodiment, the joint locking means is configured to lock the joint (3) and thereby prevent any rotation of the arm (2) when the arm is rotated such that it is at least substantially coaxial with the pile (1). The joint locking means is configured to unlock the joint and thereby allow rotation of the arm when the arm is non-coaxial with the pile. As shown in FIGS. 11a and 11b, the joint locking means is mounted on the pile (1) below the joint (3). The first engaging member comprises a first castellated portion (44a). The second engaging member comprises a second castellated portion (44b). The first castellated portion is arranged in a fixed position facing the second castellated portion. The second castellated portion (44b) is spring mounted and so that it is movable under the spring loading action of a spring (44c). The spring resiliently biases the second castellated portion towards the first castellated portion. The joint is locked when the first castellated portion and second castellated portion engage. The joint is unlocked when the first castellated portion and second castellated portion are spatially separated. The joint unlocking means further comprises control means to control the position and movement of the second castellated portion relative to the first castellated portion. The control means comprise a cam arm (50a), a locking collar (50b) and a pin member (50c). In this embodiment, the cam arm extends radially from the joint, however, it may alternatively extend radially from the arm. The locking collar is a sleeve, circumferentially mounted on the pile. The pin member is interconnected with the locking collar via a horizontally extending shaft (50d). The pin member is arranged to extend towards the second castellated portion through an aperture formed in the first castellated portion. The locking collar and thereby the pin member are movable under the action of the cam arm (50a). As shown in FIG. 11a, as the arm (2) rotates to a non-coaxial orientation to the pile, the cam arm (50a) acts downwardly on the locking collar (50b) such that it slides downwardly along the pile, consequently the pin member (50c) drives the second castellated member (44b) in a downwardly direction away from the first castellated member (44a) and the joint becomes unlocked. As shown in FIG. 11b, when the arm is substantially coaxial with the pile the cam arm has no effect on the locking collar. Hence, due to the resiliently biased spring loading action of the spring (44c) the locking collar and pin member are arranged in their respective upper most positions, the second castellated portion engages with the first castellated portion and so the joint is locked.

### B. Mounting of the Mooring Device

A second aspect of the invention relates to a method of the mounting of the mooring device in the body water. The method includes:

transporting the mooring device to a desired location in the body of water;

rotating the at least one arm with respect to the pile until the at least one arm and pile are substantially co-axial;

activating the joint locking means to lock the joint so that the mooring device becomes a rigid structure; and

driving the mooring device into the floor supporting the body of water until the pile is sufficiently embedded in the floor.

The mooring device may be driven into the floor using drive means. The mooring device may be percussively driven into the floor of the body of water using percussive drive means. Alternatively, the mooring device may be rotatably driven into the floor using rotatable drive means, particularly if the pile has a screw portion or wing portion.

The drive means may be a manually operable drive means, such as a rotatable steering handle. Alternatively, the drive means may be machine operable drive means that may be controlled remotely.

The mooring device may comprise a driving head portion for receiving the driving means. The driving head portion may be arranged in the at least one arm. In an embodiment, the driving means comprises a manually rotatable handle and the driving head portion comprises an aperture formed in the arm, whereby the handle is configured to extend through the aperture and protrude from both ends.

The mooring device is driven into the floor until the pile is sufficiently embedded in the floor to serve as an anchor and thereby maintain the position of the mooring device in the body of water. The mooring device may be driven into the floor until the stop plate abuts the floor.

The mooring device may be directionally driven into the floor so that the pile is embedded in the floor at an angle relative to a vertical axis. Alternatively, the mooring device may be vertically driven into the floor so that the pile is embedded in the floor in a direction that is substantially parallel to a vertical axis.

After mounting the mooring device in the body of water, at least one entity may be engaged to the at least one arm and the joint locking means may be deactivated to unlock the join and allow the at least one arm to rotate with respect to the pile.

### C. Mooring System

A third aspect of the invention relates to a mooring system comprising multiple mooring devices as described above.

The mooring system may comprise two or more of the mooring devices that are configured to be coupled together in the body of water. The mooring devices may be directly coupled together. For example, the second end of the arm of a mooring device may be directly coupled to an adjacent mooring device. The mooring devices may be indirectly coupled together using an interconnecting means such as a strut, bar, beam, frame or platform.

Alternatively or additionally, the mooring system may comprise two or more mooring devices that are configured to be arranged in spaced relation in the body of water.

The mooring system may be configured to form a rig or supporting structure. The mooring system may be suitable for supporting apparatus within a body of water, at the surface of a body of water and/or above a body of water. For example, the mooring system may be configured to support apparatus for drilling, monitoring, generating energy, controlling the body of water etc.

### D. Possible Uses of the Mooring Device

The mooring device according to the present invention may be used in a variety of aquatic systems. For example, the mooring device may be used to moor a floatable entity in a body of water. The mooring device may be used to moor a structure at a fixed height above the floor supporting the body of water, which is also preferably above the surface of the water. The mooring device may be used as part of a drilling rig to support an underwater drill. The mooring device may be used as part of a breakwater system to reduce erosion of the aquatic environment. The mooring device may be used as part of an aquatic wall structure to mount a wall in the body of water. The mooring device may be used as part of an energy generating system to mount the energy generating device in the body of water. The mooring device may be used as part of an underwater cabling system to mount a cabling device on the floor.

### D(i) Mooring a Floatable Entity

The mooring device according to the present invention may be used to moor a floatable entity on or near the surface of a body of water.

FIGS. 2a and 2b depict examples where mooring devices are arranged to moor floats at the surface of the water. The configuration of the float may depend on the use of the float, configuration of the mooring device and depth of water. The float is less dense than water. The float may comprise a body formed from a rigid or flexible material. The body may be filled by any suitable fluid such as air and/or water. The float may be any suitable shape such as a sphere, panel or box. The length/diameter of the float may range from 0.5 m to 5 m. The weight of the float may range from 5 kg to 1000 kg.

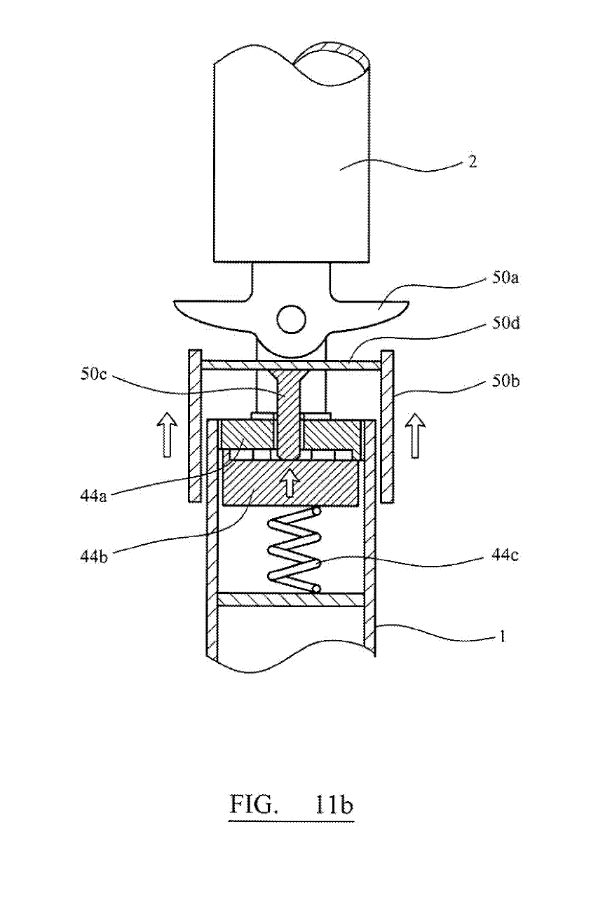

FIG. 12 depicts an example, where a first mooring device (A1) and a second mooring device (A2) are arranged to moor a boat (B) that is floating there between in the body of water (W). The piles (1) of the mooring devices are embedded in the floor (F). The mooring devices are mounted in the body of water such that the arms (2) face inwardly towards the boat. The boat is coupled to the arm of the first mooring device via a first tow rope (T1) tied to a hook (2d) arranged at the second end of the arm. The boat is coupled to the arm of the second mooring device via a second tow rope (T2) tied to a hook (2d) arranged at the second end of the arm. The arms of the mooring device may be telescopic or have a predetermined length. The maximum length of each arm is greater than the depth of the body of water. The joint (3) of each mooring device allows the respective arms to rotate in a vertical plane. Hence, the arms of the mooring device can be rotated upwardly so that an upper portion of the arms can protrude above the surface of the water and a user can easily access the hook at the end of each arm during the mooring process. During use, the joint (3) of each mooring device also allows the respective arms to rotate (rise and fall) in accordance with the contraction and extension of the tow ropes and as the tide/wave height varies. The mooring devices may be pre-installed (pre-mounted) in the body of water so that the boat is moored in a predetermined location. Floats may be moored to the pre-installed (pre-mounted) mooring devices so that the mooring devices are easily identifiable in the body of water when not in use. Alternatively, the mooring devices may be installed (mounted) in the body of water as and when required by a user so that the boat can be moored in any desirable location within the body of water.

### D(ii) Mooring of an Entity at Predetermined Height

The mooring device according to the present invention may be used to moor an entity at a predetermined height above the floor supporting a body of water. Depending on the depth of the body of water, the entity may be moored by the mooring device above the surface of the water or within the body of water.

The mooring device may be used to form a pontoon, platform or pier at least substantially above the surface of the water.

The mooring device may be used as part of or in addition to further supporting members for the entity.

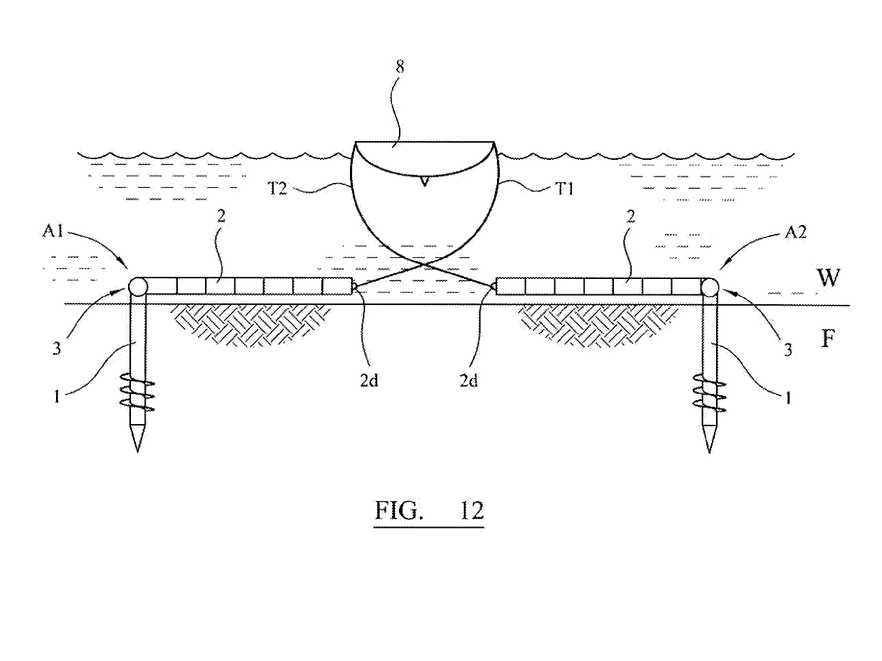

FIG. 13a depicts an example where a first mooring device (A1) and a second mooring device (A2) are arranged to moor a pontoon structure (P) above the surface of the water (W). The piles (1) of the mooring devices are embedded in the floor (F). The arms (2) of the mooring devices are coupled to the pontoon and support the pontoon at a desired (predetermined) height (H) above the floor. The joint (3) of each mooring device allows the arms to be rotated in a vertical plane until the second end of the arm is at the desired height above the floor. Engaging means (2d) at the second ends of each arm couple the mooring devices to the pontoon. The joint locking means of each mooring device are then activated to lock the joints so that the orientation of the arms is fixed and the mooring devices form a rigid mooring structure.

FIG. 13b depicts an example where mooring devices are used in conjunction with other supporting elements to mount an entity at a fixed height above a floor (F) supporting a body of water (W). In the example depicted in FIG. 12b, a first mooring device (A1), second mooring device (A2) and a plurality of pile elements (PILES) are arranged to moor a pontoon structure (P) at a predetermined fixed height (H) above the floor supporting the body of water. The pile elements may be any suitable, conventional pile element. Each pile element is an elongate body that extends substantially vertically between the pontoon and floor whereby an upper portion of each pile is coupled to the pontoon and a lower portion is embedded in the floor.

### D(iii) Drilling System

The mooring device according to the present invention may be used as part of an underwater drilling system.

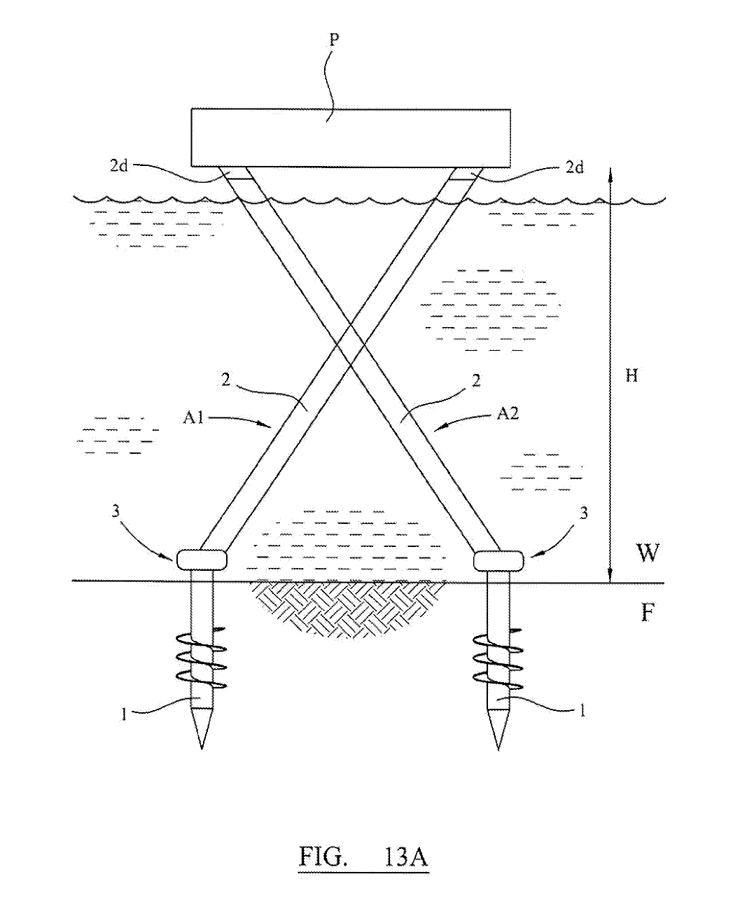

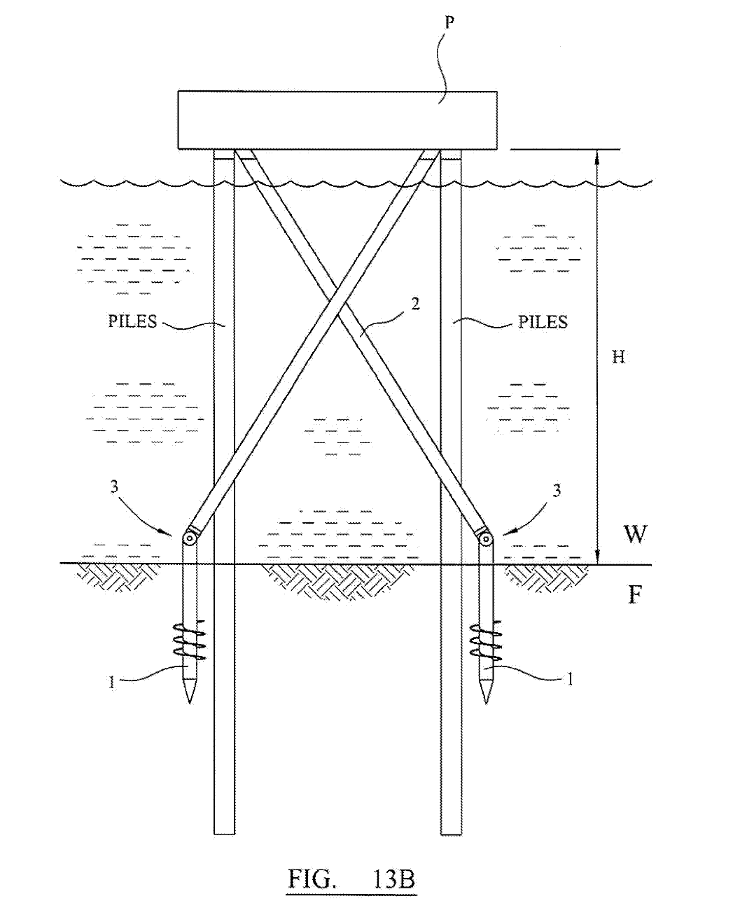

A plurality of mooring devices may be coupled together so as to form a mooring system for supporting drilling means. For example, FIGS. 14a and 14b depicts an example where four mooring devices (A1, A2, A3, A4) are coupled together at a platform (PL) so as to form a drilling rig that is able to support a drill (D) within a body of water and guides it towards the floor (F).

### D(iv) Breakwater

The mooring device according to the present invention may be used as part of a breakwater. A breakwater is a device located offshore or onshore for absorbing energy from a moving body of water and for impeding the flow of moving water. By absorbing kinetic energy and impeding the flow, a breakwater can help to protect aquatic structures such as harbours and marinas. A breakwater can be used as coastal defence and reduce erosion of the aquatic environment. A breakwater can control the build-up of deposits (such as rocks, sand and silt) in an aquatic environment. The breakwater may be in the form of a revetment.

The breakwater comprises at least one energy absorbing means and at least one mooring device according to the first aspect of the invention for mounting the energy absorbing means in the body of water. The at least one energy absorbing means may be coupled to the at least one arm of the mooring device.

The at least one energy absorbing means may be configured to absorb moving energy from the body of water by being movable under the action of the moving body of water. The joint of the mooring device allows the at least one absorbing means (and thereby the at least one arm) to move under the action of the body of water. According to the laws of momentum, the motion of the at least one absorbing means (and the at least one arm) represents a transfer of kinetic energy from the moving body of water to the at least one absorbing means.

The at least one absorbing means may include at least one deflecting surface to deflect or inhibit the flow of water.

The at least one absorbing means may be alternatively or additionally comprise voids (apertures, recesses) that are configured to absorb moving energy from the body of water and inhibit the flow of water. The voids (apertures, recesses) absorb moving energy and inhibit the flow of water by creating energy dissipating turbulence.

The energy absorbing means may be a floatable means that is floatable in the body of water or on the surface of the water when moored by the at least one mooring device. The floatable means may have a substantially solid (continuous) structure or a discontinuous structure having a plurality of voids (apertures, recesses). For example, the floatable means panel may have a grid or frame-like structure with a regular array of voids. The voids (apertures, recesses) in the floatable means help to dissipate energy. The floatable means may be a rigid structure whereby the shape of the floatable means remains substantially constant under the action of the moving body of water. Alternatively, the floatable means may be a deformable structure that is deformable under the action of the moving body of water. The floatable means may comprise any suitable material or materials such that the floatable means is less dense than the body of water and it has sufficient structural integrity to withstand the forces of the moving body of water. The floatable means is mounted in the body of water by coupling the floatable means to at least one arm of at least one mooring device.

The energy absorbing means may be a substantially rigid structure that is able to substantially maintain its shape under the action of the moving body of water.

The energy absorbing means may be a deformable structure means is able to change shape (e.g. expand and contract) under the action of the moving body of water.

The energy absorbing means may have a two-dimensional shape or a three-dimensional shape. For example, the energy absorbing means may have a cuboid shape or a triangular prism shape. The energy absorbing means may comprise at least one panel (wall-like element). The energy absorbing means may comprise a plurality of panels configured to form any suitable three-dimensional shaped structure. The panels may be rigidly or freely coupled together using any suitable coupling means. The panel may have a solid (continuous) structure or a discontinuous structure having a plurality of voids (apertures, recesses). For example, the panel may have a grid or frame-like structure with a regular array of voids. The voids (apertures, recesses) in the panel help to dissipate energy. The panel may be rigid or flexible. The panel may be formed from a metal, fibreglass, basalt fibre, plastic, rubber, textile, concrete or any suitable material that is rust proof and has sufficient structural integrity to withstand the forces of the moving body of water. The panel may comprise additional strengthening means. The additional strengthening means may comprise a matrix formed from a plastics material, carbon fibre or rubber.

The energy absorbing means may comprise at least one fluid inlet. The fluid inlet allows the energy absorbing means to fill with water so as to improve the mass of the energy absorbing means and therefore the absorption of moving water energy. The panel of the energy absorbing means facing the direction of flow helps to deflect or impede the flow of the body of water. The energy absorbing means may be mounted in the body of water by coupling a mooring device to each corner of the energy absorbing means.

The breakwater may be used in conjunction with an energy harnessing or generating means to harness the kinetic energy of the moving body of water and convert it to other forms of energy.

Multiple breakwater devices may be coupled together to form a breakwater system.

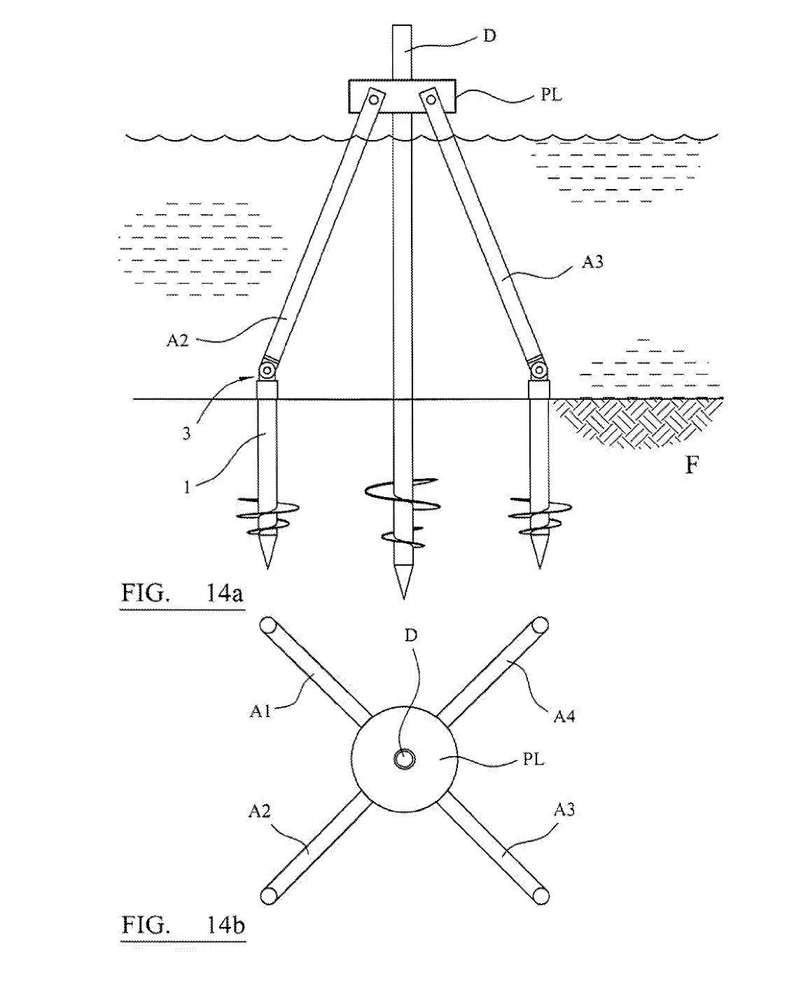

FIG. 15 depicts a first example of a breakwater device. The breakwater comprises a floatable means (B) coupled to a mooring device according to the first aspect of the invention. The pile (1) of the mooring device is embedded in the floor (F) supporting the body of water (W). Engaging means (2d) arranged at the second end of the arm (2) rigidly couple the floatable member to the mooring device. The mooring device is configured to mount the floatable member at or near the surface of the body of water. The joint (3) of the mooring device allows the arm to rotate in a vertical plane so that the height of the arm (and therefore the floatable member) can change. The joint allows the arm to rotate in a vertical plane so that the floatable member can be floated in different depths of water and can continue to float on or near the surface of the body of water as the depth of water changes. The joint may also allow the arm to rotate in a horizontal plane so that the direction of the arm (and therefore the floatable member) can change. To help maximise the absorption of the energy and deflection of the waves, the joint may also allow the arm to rotate in a horizontal plane so that the arms extends in the direction of flow (FLOW) and a deflecting surface (D) of the floatable member is aligned substantially parallel to the wave crests.

As the body of water collides with the floatable member, kinetic energy is transferred from the moving body of water to the floatable member and arm. The deflecting surface of the floatable device inhibits the flow of the body of water. The joint allows both the floatable member and arm to be driven to rotate in the body of water as the kinetic energy is transferred from the moving body of water. The rotation of the floatable member and arm helps to dissipate the kinetic energy transferred from the moving body of water. Reciprocating rotation of the floatable member and arm in a vertical plane is indicative of kinetic energy being transferred from the body of water as it moves under the oscillating tidal and/or wave action. The joint therefore helps to optimise the performance of the breakwater.

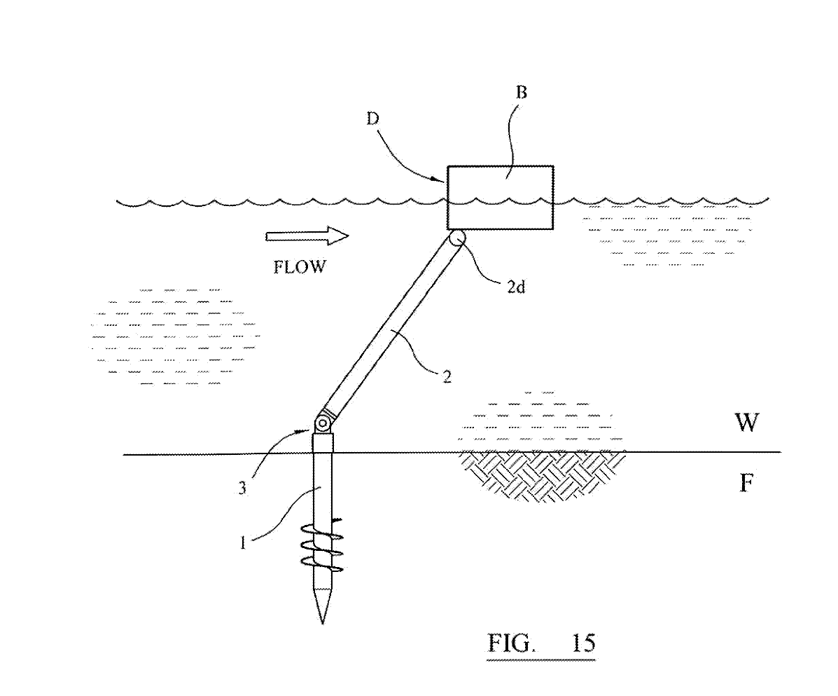

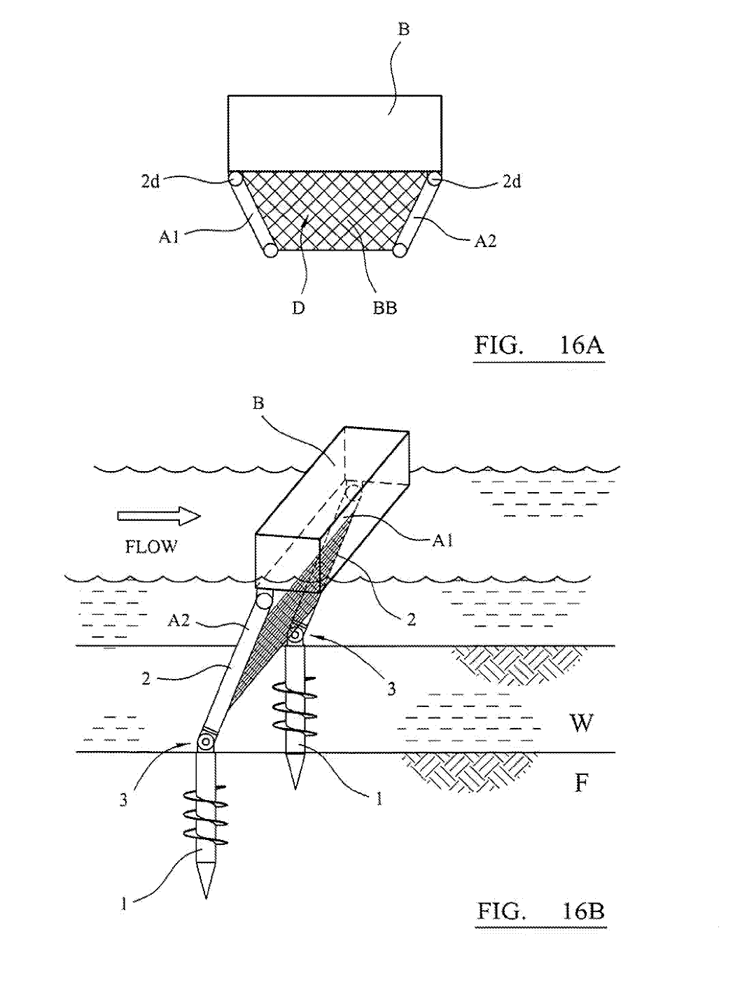

FIGS. 16a and 16b depict an example of a breakwater device comprising a substantially rigid barrier means (BB) mounted in a body of moving water (W) and a floatable means (B) mounted on the surface of the body of moving water. In this example, the barrier means is a rigid, solid panel extending between a first mooring device (A1) and a second mooring device (A2). As the body of moving water collides with a deflecting surface (D) of the barrier means kinetic energy is transferred from the water to the barrier means. The deflecting surface of the barrier means also deflects or inhibits the flow of the moving water (FLOW). The sidewalls of the barrier means comprise channels that are configured to receive at least a part of the arms of each mooring device. Hence, the barrier means can be slidably mounted on the mooring devices by sliding the arms along the channels. The floatable means is mounted by the first mooring device and second mooring device so as to float on the surface of the body of water between the first mooring device and second mooring device. The floatable means is provided to help resist the overturning forces of the moving body of water and return the barrier means to a substantially upright configuration during use. The floatable means also helps to absorb moving water energy and inhibit the flow of moving water. The piles (1) of the mooring devices are embedded in the floor (F). Engaging means (2d) at the second ends of the arms (2) couple the floatable means to the mooring devices. The joint (3) of each mooring device allows the arms and therefore the barrier means and floatable means to rotate in a vertical plane in the body of water under the colliding action of the moving body of water. The rotation of the barrier means and floatable means is indicative of the absorption of energy from the moving body of water. The joint of each mooring device allows the arms to rotate in a vertical plane during use so that they can rise and fall in accordance with the depth of the body of water. Thus, the height of the breakwater relative to the floor varies in a reciprocating fashion due to the oscillating tidal and/or wave motion. The joint of each mooring device may also allow the arms to rotate in a horizontal plane so that they are always orientated in the direction of the flow. Hence, the deflecting surface of the barrier means is always aligned substantially perpendicular to the direction of flow so as to maximise the absorption of energy and deflection of flow.

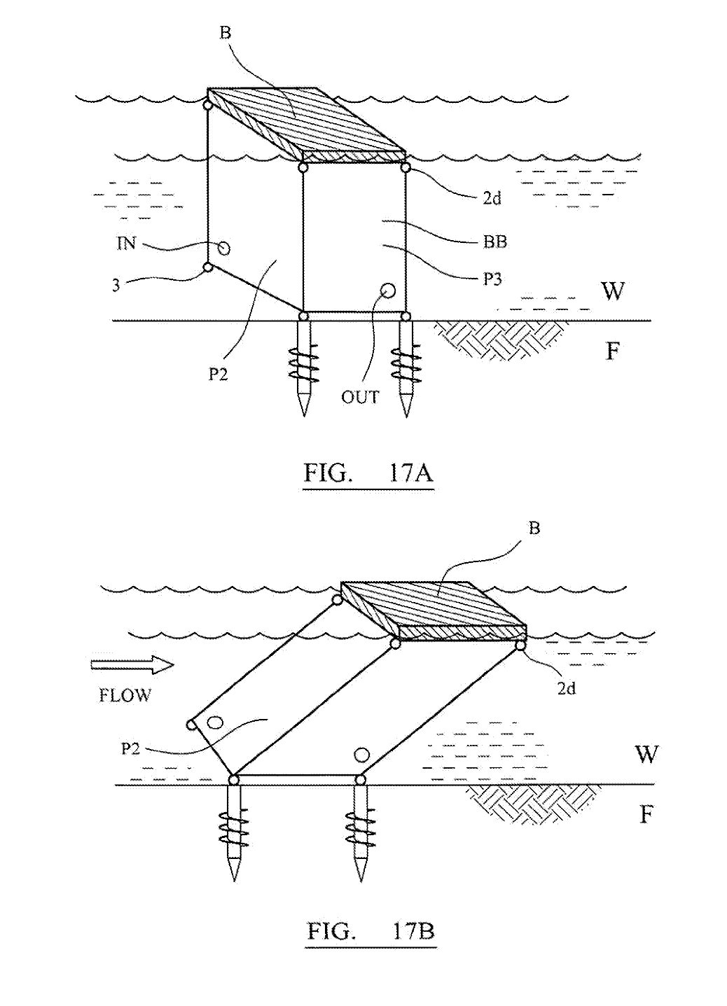

FIGS. 17a and 17b depict an example of a deformable breakwater device comprising a deformable barrier means (BB) and a floatable member (B). The barrier means comprises a plurality of rigid panels that are configured to form a cuboid. The barrier means comprises a front panel (P1), a rear panel (P2), side panels (P3, P4), an upper panel and lower panel. The rigid panels of the breakwater barrier are freely coupled together so that the panels can move relative to one another when an external force acts on the barrier means and/or when the arms of the mooring devices rotate.

The cross-sectional dimensions (length and width) of the floatable means correspond to the cross-sectional dimensions (length and width) of the barrier means. The barrier means and floatable means are mounted in the body of moving water by coupling a mooring device to each of the respective corners of the barrier means and floatable means. The floatable means is moored by the mooring devices by using engaging means (2d) arranged at the second ends of each arm (2) of the mooring device to couple the corners of the floatable means. The barrier means is slidably mounted on the mooring devices by sliding at least a part of each arm along a corresponding channel formed in each corner edge of barrier means. The barrier means is mounted at least substantially below the surface of the body of moving water by the mooring devices. The floatable means is mounted at least substantially at the surface of the body of moving water by the mooring devices.

The floatable means helps to resist the overturning forces of the moving body of water and return the breakwater to a substantially upright position.

The joint (3) of each mooring device allows the arms and therefore the barrier means and floatable means to rotate in the body of water under the action of the moving body of water. Due to the direction of the flow (FLOW), the body of moving water collides with the rear panel (P2) of the barrier means. The impact of the body of moving water causes the barrier means to tilt in the direction of flow and it subsequently deforms from a cuboid to a parallelepiped.

The barrier means comprises a fluid inlet (IN) and a fluid outlet (OUT). The fluid inlet allows water to enter the barrier means. The fluid outlet allows fluid to exit the barrier means. The joint of each mooring device allows the arms to rotate in a vertical plane during use so that they can rise and fall in accordance with the depth of the body of water. It is known and understood that the depth of the body of water oscillates during tidal and/or wave motion. Therefore, when the depth of the body of water decreases, the joints (3) of each mooring device allow the arms to rotate downwardly in a vertical plane under the action of the body of water such that the barrier means deforms from a cuboid (upright position, expanded condition) to a parallelepiped (tilted position, contracted condition). As the depth of the body of water increases and the floatable means seeks to return the barrier means to the upright position, the joints allow the arm to rotate upwardly in a vertical plane so that the barrier means is returned to a substantially upright position and it changes from a parallelepiped (contracted condition) to a cuboid (expanded condition). Therefore, under tide and/or wave motion, the barrier means moves in a reciprocating fashion between a substantially upright position (expanded condition) as shown in FIG. 17a and a tilted position (contracted condition) as shown in FIG. 17b. As a result, the height of the barrier means is able to vary in accordance with the depth of the body of water and does not protrude above the surface when the depth of water decreases.

As the barrier means returns from a tilted position (contracted condition) to a substantially upright position (expanded condition), the cross-sectional area of the barrier means increases and the internal pressure decreases. Hence, fluid is drawn into the barrier means via the fluid inlet. As the barrier means is driven from a substantially upright position (expanded condition) to a tilted position (contracted condition), the cross-sectional area of the barrier means reduces and the internal pressure within the barrier means increases. Hence, fluid is subsequently forced to flow out of the barrier means via the fluid outlet. Accordingly, the barrier means of the breakwater acts as a pump that is driven by the reciprocating motion of the body of water. The pumping action of the barrier means may be utilised for any suitable purpose. For example, the pumping action of the breakwater may drive a hydroelectric transducer. So as to optimise the harnessing of energy and deflection of the body of water, the joint of each mooring device may also allow the arms to rotate in a horizontal plane so that the arm extends in the direction of flow and the rear panel is aligned substantially perpendicular to the direction of flow.

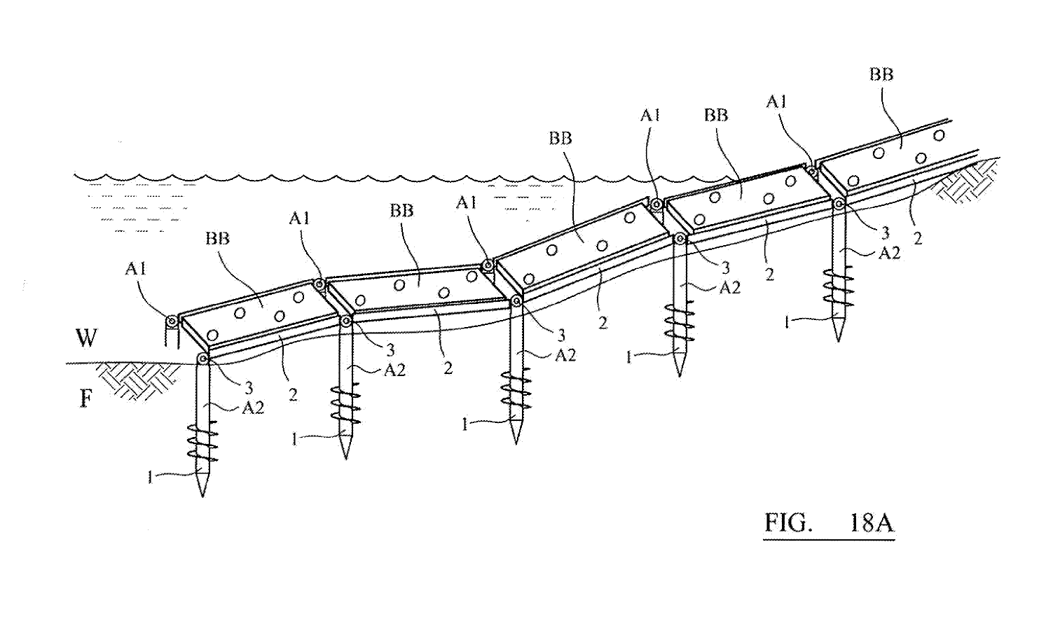

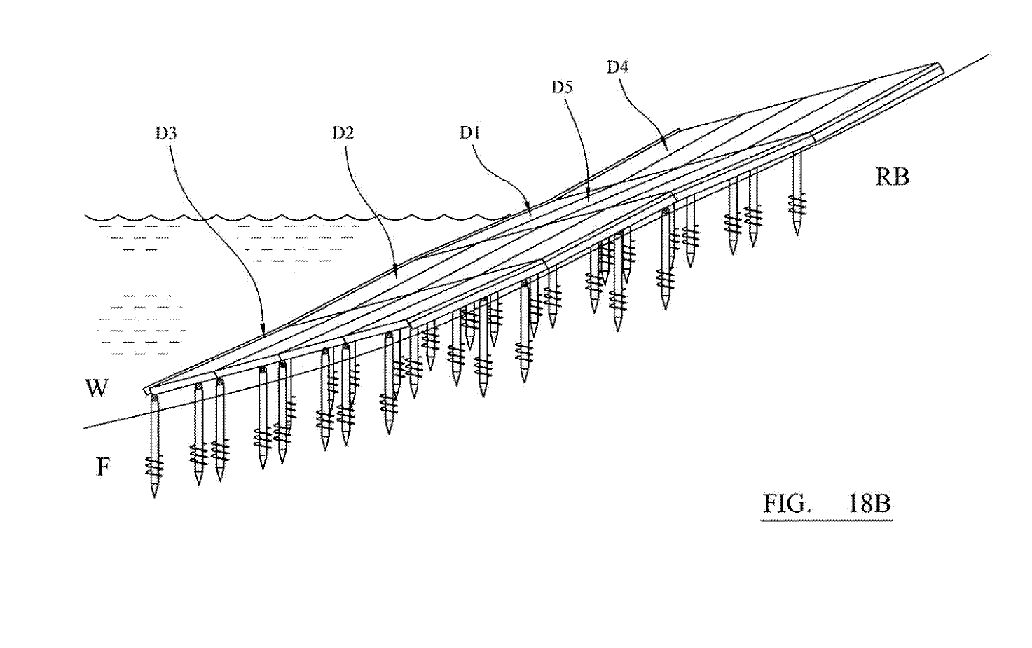

FIGS. 18a and 18b depicts an example of a breakwater system comprising a plurality of breakwater devices mounted along a surface. The surface may be any suitable surface associated with a body of water on which a breakwater device can be mounted. The surface may be the floor of a body of water, coastline, riverbank, shoreline and/or cliff.

In the example depicted in FIGS. 18a and 18b, the breakwater system comprises a linear array of breakwater devices (D1, D2, D3 etc.) that are mounted to protect a riverbank (RB). Due to the depth of the river, a lower portion of the breakwater system is mounted on the riverbank below the water level whilst an upper portion is mounted on the riverbank above the water level. Each breakwater device comprises a barrier means (BB) mounted on the riverbank floor (RB) using mooring devices according to the present invention. In the example depicted in FIGS. 16a and 16b, each barrier means (BB) is a hollow block comprises a plurality of apertures formed in the upper surface of the block. Each barrier means is mounted to extend between a first mooring device (A1) and a second mooring device (A2). The piles (1) of the mooring devices are embedded in the riverbank (F). The barrier means is coupled to the arms (2) of mooring devices by sliding the arms through channels formed in opposing edges of the breakwater barrier. The joint of each mooring device allows the arms to rotate in a vertical plane so that the barrier means can be arranged to extend along the riverbank. Engagement means (2d) arranged at the second end of each arm are configured to engage a mooring device of an adjacent breakwater device so that a plurality of breakwater devices can be coupled together in an array. In the embodiment depicted in FIGS. 18a and 18b, the engagement means at the second end of each arm is coupled to the first end of the arm of an adjacent mooring device. The joint locking means allow the arms to be locked so that the orientation of the mooring devices is fixed and they form a rigid mooring structure. Hence, the breakwater devices remain at least substantially rigid and stationary as the moving body of water (the river) collides with the breakwater system. The breakwater devices absorb energy from the moving body of water and impede the flow of water as water flows in/out of the hollow bodies via the apertures.

### D(v)Aquatic Wall

The mooring device according to the present invention may be used as part of an aquatic wall arranged in a body of water.

The aquatic wall comprises at least one barrier panel and at least one mooring device for mounting the at least one barrier panel in a body of water. When mounted in the body of water, the at least one barrier panel is configured to form a wall or blockade.

Depending on its use, the barrier panel may be permeable, semi-permeable or substantially impermeable. The barrier panel may be substantially rigid or flexible. The barrier panel may comprise a membrane filled with water or any other suitable material to improve its rigidity. The barrier panel may comprise a mesh.

Multiple aquatic wall devices may be coupled together to form an aquatic wall system. The aquatic wall system may have any suitable shape. For example, the aquatic wall system may be substantially linear, irregular, curved, square or rectangular shaped. One or more end portions of the aquatic wall system may be angled relative to a central portion of the aquatic wall.

The aquatic wall may be used to form a harbour or aquatic structure, to form a reservoir or lagoon, to form a dam or lock, to guide the flow of water, to form an aquatic leisure facility, to form an exclusion area within a body of water, to act as a safety barrier (e.g. to stop sharks, jelly fish and/or any other types of animal), to form an artificial territory suitable for reducing the adverse environmental impacts of dredging, to form a flood defence, to form a breakwater/coastal defence, to form a revetment or any other suitable purpose.

The aquatic wall may be used in conjunction with an energy harnessing or generating means. For example, the aquatic wall may be used in conjunction with energy harnessing means to form a tidal barrage in a bay or river so as to generate electricity from a body of water that moves due to tidal forces.

Since the mooring devices are easy to transport and install and can be temporarily mounted in a body of water, the aquatic wall may be used to form a temporary aquatic wall.

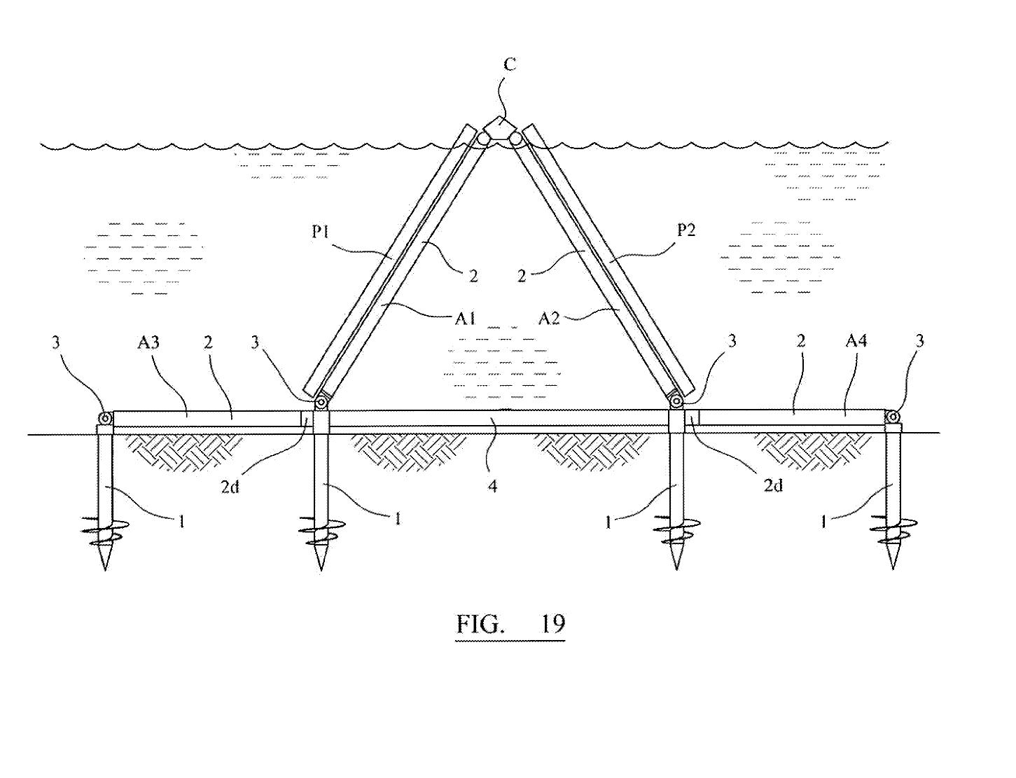

FIG. 19 depicts an example of an aquatic wall structure comprising a wall mounted in a body of water (W) using a mooring system having a plurality of mooring devices according to the present invention. The wall comprises a first panel (P1) and a second panel (P2) coupled together using coupling means (C) to form a triangular-prism wall. The first panel is moored in the body of water by a pair of mooring devices (A1). The second panel is moored in the body of water by a second pair of mooring devices (A2). The panels extend between the arms (2) of the respective pairs of mooring devices. It can be seen in FIG. 19 that the mooring devices and panels are configured such that that the side edges of the panels extend substantially along the length of the arms (2) of the mooring devices. The panels are secured to the arms using any suitable engaging means (not shown). Further mooring devices (A3, A4) are used to help securely moor the aquatic wall structure in the body of water. These additional mooring devices are coupled to the mooring devices supporting the panels using engaging means (2d) arranged at the second ends of the arms. A strut (4) is mounted between the pairs of mooring devices to provide further structural integrity to the mooring system. The piles (1) of the mooring devices are embedded in the floor supporting the body of water. The joints (3) of the mooring devices allow the arms to rotate to the desired orientation. The joints allow the arms to rotate in a vertical plane. The joint may also allow arms to rotate in a horizontal plane. For example, when forming the aquatic wall, the arms of the mooring devices supporting the panels are rotated so that they are orientated to extend upwardly towards the surface of the body of water. The arms of the additional mooring devices are orientated to extend adjacent or along the floor towards the mooring devices supporting the panels.

### D(vi) Underwater Laying System

The mooring device according to the present invention may be used as part of an underwater laying system. The underwater laying system may be suitable for laying at least one cable and/or at least one pipe along the floor supporting the body of water.

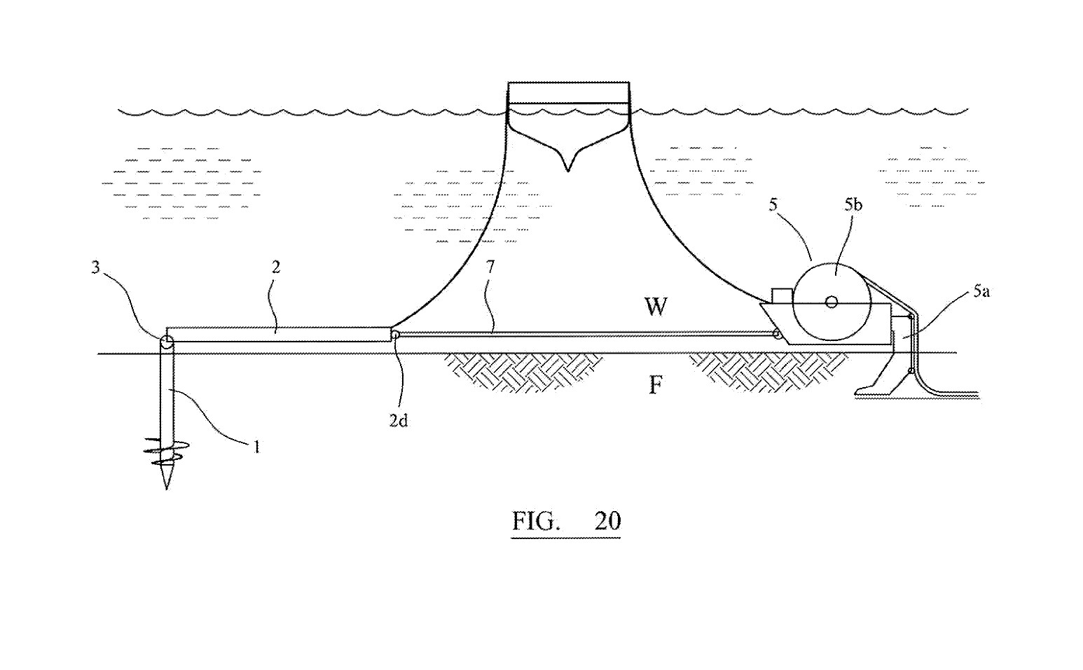

FIG. 20 depicts an example of a cable laying system whereby a mooring device according to the present invention mounts an underwater cable laying device on the floor of a body of water. The underwater cable laying device may be any conventional underwater cable laying device. The cable laying device (5) may comprise a plough (5a) and a winch (5b). The plough is configured to form a cable shaped recess in the floor. The winch (5b) is configured to unwind a coil of cable (6) so that it can be located in the recess and move the device along the floor towards the mooring device. The cable laying device is coupled to the arm (2) of the mooring device via a cable (7) tied to a hook (2d) at the second end of the arm. The joint (3) of the mooring device allows the arm to rotate in a vertical plane, and optionally a horizontal plane, so that the arm can be orientated to extend towards the cable laying device. The pile (1) of the mooring device is temporarily embedded in the floor (F) so that the mooring device can be moved to a new location for laying cables as and when required.

D(vii) System for Harnessing Energy from a Body of Moving Water

The mooring device according to the first aspect of the invention may be used as part a system for harnessing energy from a moving body of water.

The system for harnessing energy from a moving body of water comprises at least one energy harnessing device and at least one mooring system to moor the at least one energy harnessing device in the moving body of water.

The energy harnessing device is configured to be driven by the moving body of water and thereby harness the kinetic energy from the moving body of water and convert it to other forms of energy. For example, the energy harnessing device may be configured to harness the motion of the body of moving water to generate electricity. The energy harnessing device may be configured to harness the motion of the body of water to drive a pump for pumping a fluid.

The system for harnessing energy may comprise any suitable energy harnessing device for harnessing the motion of the body of water. The energy harnessing device may comprise a rotatable actuator (e.g. a turbine, a flywheel), a linear actuator (e.g. a rack and pinion), a hydraulic actuator (e.g. a hydraulic piston pump), an electromagnetic actuator or a deformable pumping body actuator driven under the action of the moving body of water.

The system for harnessing energy may comprise at least one guide member for guiding the moving body of water towards the energy harnessing device. By focussing the body of water towards the energy harnessing device, the water pressure and/or water speed acting on the energy harnessing device increases and so the operation of the energy harnessing device is improved. The at least one guide member may have any suitable configuration for focussing the body of water, such as a sail configuration. The at least one guide member may comprise any suitable material that provides sufficient structural integrity to withstand the forces of the moving body of water, such as carbon fibre. The position of the at least one guide member may be adjusted depending on the direction of flow, the type of energy harnessing device and the type of mooring device.

The configuration of the system for harnessing energy is dependent on the intended use, permanence or temporary nature of the system, size, shape, weight, and type of energy harnessing device, type of floor, depth of water, waver height and/or tidal range. For example, the system for harnessing energy may be scaled for temporary personal use so that a user can easily transport and mount the system in any suitable moving body of water as and when he requires. The user may use the system to generate electricity or pump a fluid.

The energy harnessing device may comprise at least one turbine that is configured to rotate under the action of the moving body of water. The turbine comprises a rotor assembly with one or more blades attached. The turbine may have any suitable design. For example, the turbine may be a Savonius turbine design, Darrieus turbine design and/or Gorlov turbine design.

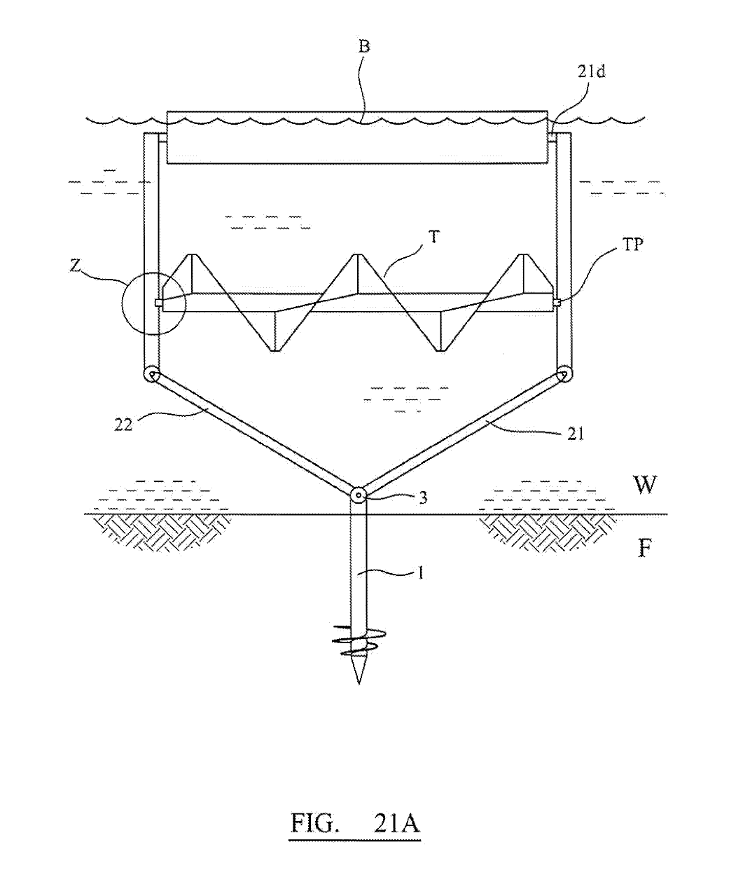

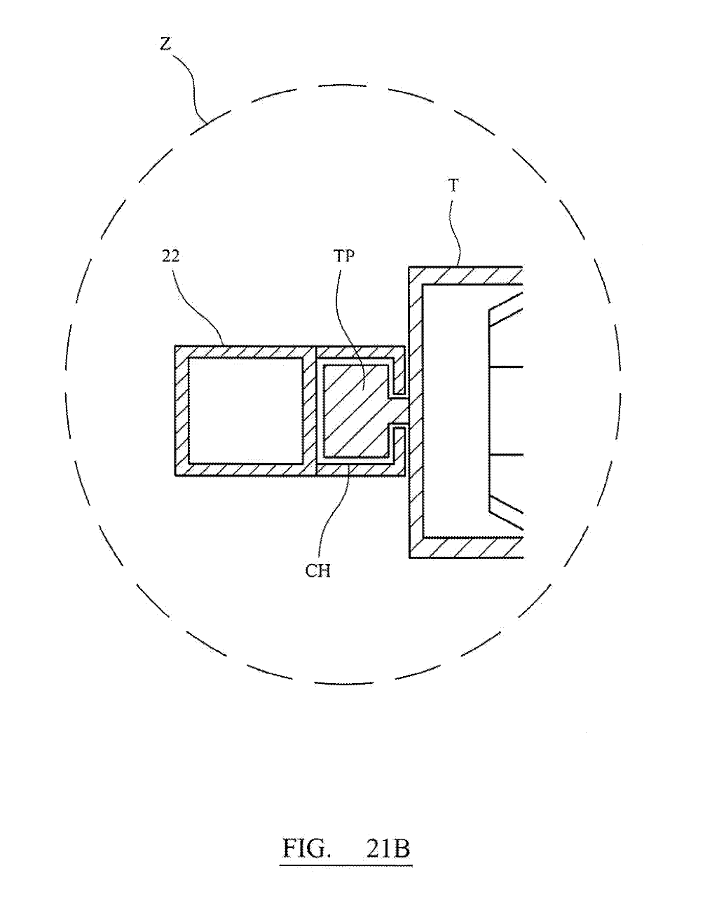

FIGS. 21a and 21b (see also FIG. 2c) depicts an example of an energy harnessing system comprising a turbine device (T) and floatable member (B) mounted in a body of water (W) by a mooring device. The mooring device comprises a pile (1) configured to be embedded in a floor (F), a first arm (21) and second arm (22) coupled to the pile via a joint (3) and a joint locking means (not shown). The floatable member (B) is configured to float on the surface of the water when it is coupled to the second ends of the first arm and second arm using engaging means (21, 22dd). The floatable member is provided to keep the turbine device in a generally upright position in the body of water. The turbine device (T) is configured to extend between the first arm and the second arm. The turbine device comprises multiple blades extending helically along a horizontally extending rotor. The turbine is configured to harness energy from the moving body of water. The turbine is driven to rotate when the moving of the body of water acts on the blades. The turbine may be coupled to an electromechanical transducer to convert the rotational motion of the turbine into electricity (not shown). As can be seen in section Z depicted in FIG. 21b, the turbine is slidably mounted on the arms of the mooring devices by sliding a protruding portion (TP) formed at either end of the rotor into a channel (CH) formed in each respective arm. The turbine is preferably located in a central portion of the body of water where the driving force of the body of water is a maximum. So as to maintain the optimum operating position for the turbine in different or varying depths of water, the joint of the mooring device allows the arm to rotate in a vertical plane so that the height of the arm can be adjusted in accordance with the depth of the water. So as to maximise the driving effect on the turbine, the joint may allow the arms to rotate in a horizontal plane so that the arms are always orientated in the direction of flow and the turbine extends perpendicular to the direction of flow to maximise the driving effect.

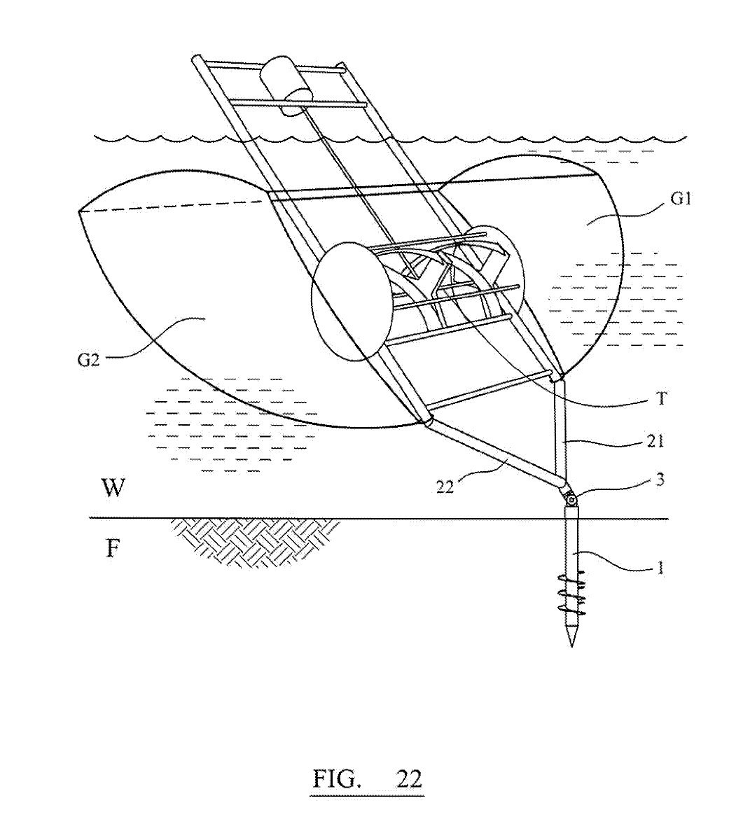

FIG. 22 depicts an alternative example of a turbine device (T) mounted in a body of water (W) by a mooring device. As with the mooring device depicted in FIG. 2c, the mooring device comprises a pile (1) embedded in the floor (F), a first arm (21) and a second arm (22) coupled to the pile via a joint (3) and a joint locking means (not shown). The turbine device extends between the first arm and second arm. The first arm and second arm are sufficiently buoyant so as to keep the turbine device in a generally upright position in the body of water. A first guide member (G1) and a second guide member (G2) are arranged on either side of the turbine so as to focus the moving body of water towards the turbine and thereby enhance the rotation of the turbine. In this embodiment, the guide members are interconnected via booms and coupled to the respective arms.

The energy harnessing device may comprise at least one flywheel and corresponding driving shaft whereby the flywheel and corresponding driving shaft are mounted on the mooring device such that the flywheel can be driven by the driving shaft under the reciprocating motion of the arm, which is caused by the oscillating wave and/or tide motion acting on the floatable member.

The flywheel may be single action flywheel that is configured to be rotated when the arm moves in a predetermined (single) direction. However, the flywheel may be a double action flywheel that can be driven to rotate during both the downward motion and upward motion of the float and arm. The flywheel may be configured to rotate in the same direction throughout the reciprocating cycle. The flywheel may be coupled to an electromechanical transducer to convert the rotational motion of the flywheel into electricity.

For example, an energy harnessing system may comprise a mooring device according to a first aspect of the invention, a float, a flywheel and a corresponding driving shaft. The mooring device comprises a pile configured to be embedded in the floor, an arm, a joint and joint locking means. A first end of the arm is coupled to the pile via the joint. A second end of the arm is configured to be coupled to the float using engaging means. Hence both the float and arm move under the action of the moving body of water. The joint is configured to permit the rotation of the float and arm in a vertical plane relative to the pile. If the body of water is moving due to tide and/or wave motion, the joint allows the float and arm to rotate in the vertical plane so that the height of the arm varies in a reciprocating fashion. The flywheel is mounted on the arm. The driving shaft is mounted to extend from the pile to the flywheel so as to drive the flywheel as the arm rotates in a vertical plane relative to the pile. Thus, as the float moves under the tide and/wave motion, the arm rotates in a vertical plane relative to the pile and the driving shaft drives the flywheel such that the flywheel is rotated.

The energy harnessing device may comprise at least one pinion and corresponding rack whereby the pinion and corresponding rack are mounted on the mooring device such that the pinion can be driven to rotate along the rack under the reciprocating motion of the arm.

The at least one pinion may be configured to be to rotate in the same direction during the reciprocating cycle.

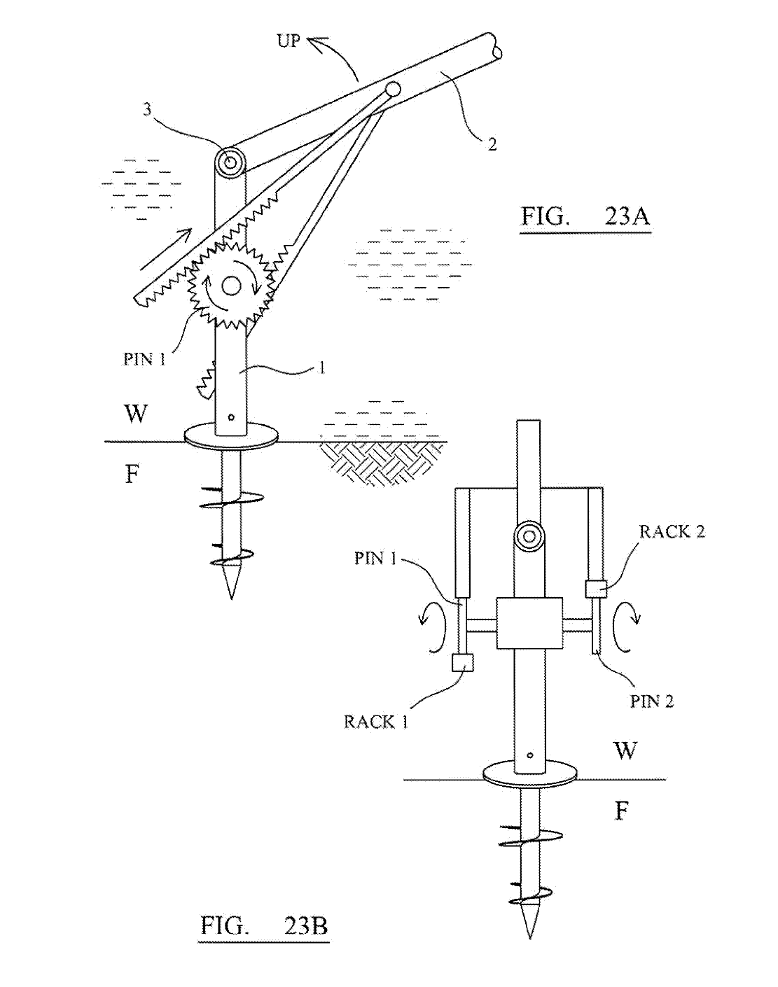

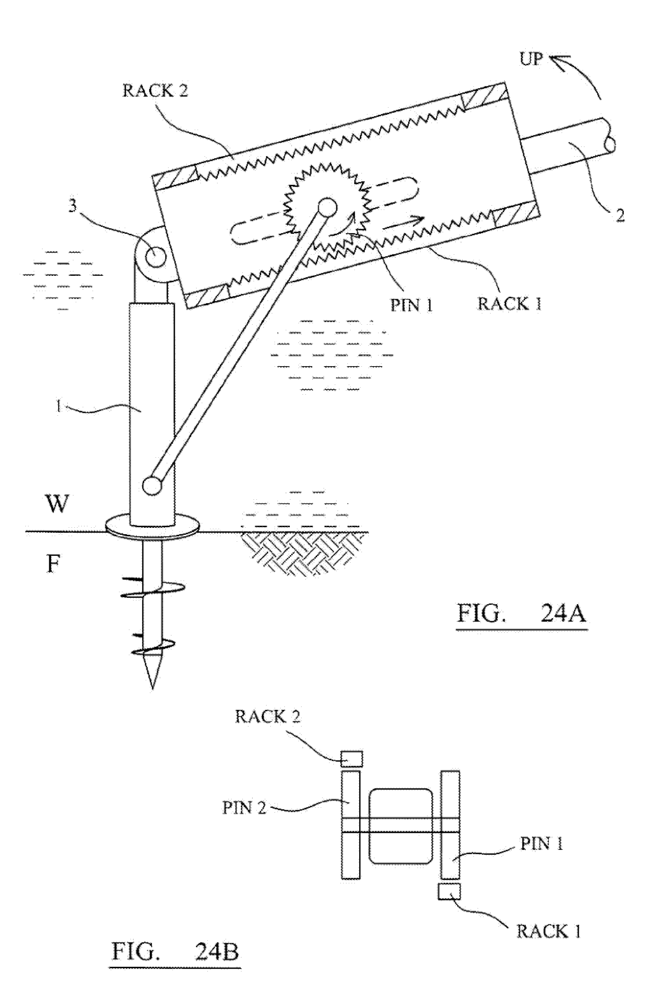

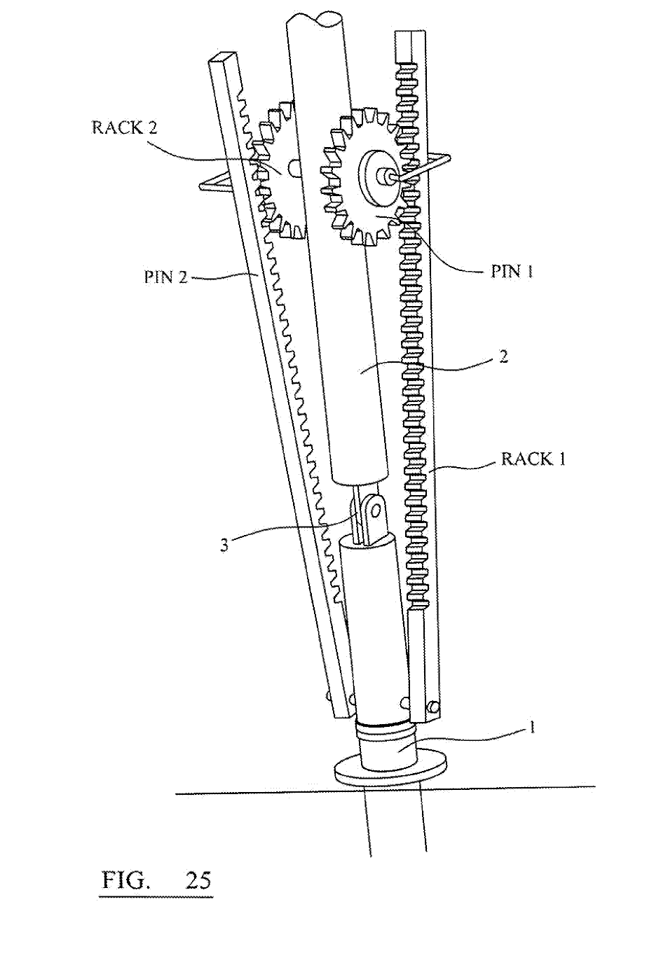

FIGS. 23a, 23b, 24a, 24b and 25 depict three different examples of energy harnessing systems that utilise rotatable pinions and corresponding racks. In each case, the energy harnessing system comprises a mooring device according to the first aspect of the invention, a float (not shown) and an energy harnessing device that comprises a first rack and pinion and a second rack and pinion. The joint (3) is configured to permit the rotation of the float and arm in a vertical plane relative to the pile. The float is coupled to the arm such that the float and arm move under the action of the water. If the body of water is moving due to tide and/or wave motion, the joint of the mooring device allows the float and arm to rotate in the vertical plane so that the height of the arm varies in a reciprocating fashion. The first pinion (PIN1) and second pinion (PIN2) are rotationally mounted on opposing sides of the mooring device. The first pinion is configured to be driven along the first rack (RACK 1) in a predetermined rotational direction as the arm moves downwardly. The second pinion is configured to be driven along the second rack (RACK 2) in the same predetermined rotational direction as the arm moves upwardly. Hence, the first and second pinions in each system are able to rotate in the same direction throughout the reciprocating cycle. The pinions may be coupled to an electromechanical transducer to convert the rotation motion of the pinions into electricity.

The energy harnessing device may comprise at least one pump that is mountable in the moving body of water by at least one mooring device according to a first aspect of the invention. The pumping action of a pump within an energy harnessing system is dependent on the reciprocating tide and/or wave motion acting on the arm (and optional float) and the change in height of the arm during reciprocating motion.

The pump of an energy harnessing system may be sealed hydraulic system that is configured to pump any suitable hydraulic fluid. The pump may be configured to draw in water from the moving body of water. The pump may be configured to pump fluid to a remote location. The pump may be coupled to a transducer to convert the pumping action of the pump to other forms of energy. For example, the pump may be coupled to a hydroelectric transducer to convert to action of the pumped fluid into electricity.

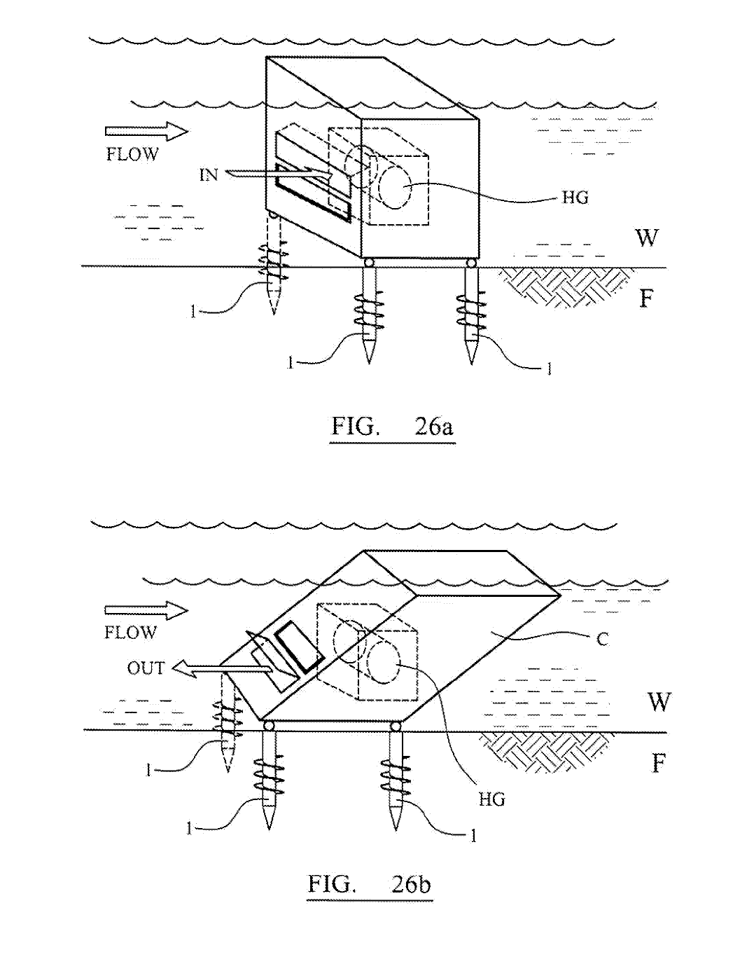

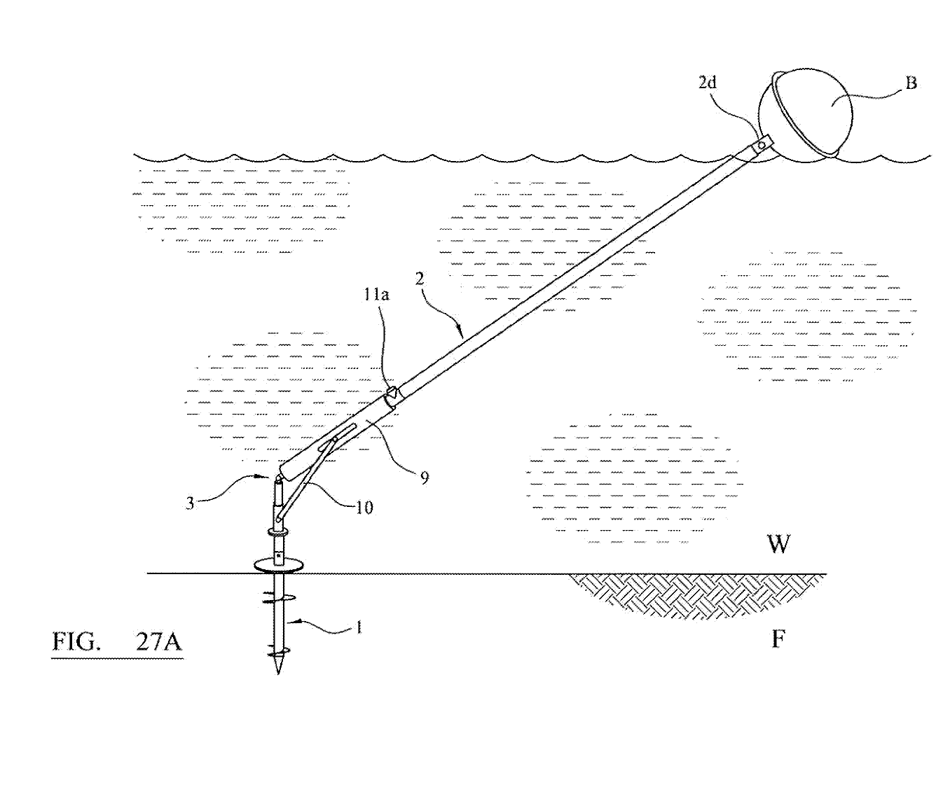

FIGS. 26a and 26b depict an example of an energy harnessing system with a deformable pumping chamber (C). The chamber is generally cuboid in shape and comprises a front wall, rear wall, side walls, an upper wall and a lower wall. The chamber comprises a fluid inlet (IN) and a fluid outlet (OUT). A hydroelectric transducer (HG) is mounted within the chamber adjacent to the fluid inlet and fluid outlet. The chamber is mounted in the body of water by coupling a mooring device to each corner of the chamber. Each corner edge is slidably mounted or coupled to the arm of a respective mooring device. The arms of the mooring devices are sufficiently buoyant so as arrange the chamber in a generally upright position within the body of water.

The joint (3) of each mooring device allows the arms and therefore the chamber to rotate in the body of water under the action of the moving body of water. Due to the direction of the flow (FLOW), the body of moving water collides with the rear wall of the chamber. The impact of the body of moving water causes the arms to rotate and the chamber to deform. As the depth of the body of water decreases, the arms to rotate downwardly in a vertical plane so that the chamber deforms from a cuboid (an upright position, expanded condition) to a parallelepiped (tilted position, contracted condition). As the depth of the body of water increases, the buoyant arms rotate upwardly in a vertical plane so that the chamber is returned to a substantially upright position and it changes from a parallelepiped (contracted condition) to a cuboid (expanded condition). Therefore, under tide and/or wave motion, the chamber moves in a reciprocating fashion between a substantially upright position (expanded condition) as shown in FIG. 26a and a tilted position (contracted condition) as shown in FIG. 26b.

As the chamber returns from a tilted position (contracted condition) to a substantially upright position (expanded condition), the cross-sectional area of the chamber increases and the internal pressure decreases. Hence, fluid is drawn into the chamber via the fluid inlet. As the chamber is driven from a substantially upright position (expanded condition) to a tilted position (contracted condition), the cross-sectional area of the chamber reduces and the internal pressure within the chamber increases. Hence, fluid is subsequently forced to flow out of the chamber via the fluid outlet. Accordingly, the deformable chamber acts as a hydraulic pump that is driven by the reciprocating motion of the body of water. In this particular embodiment the pumping action of the inflow and outflow of fluid is utilised to drive the double action hydroelectric transducer.

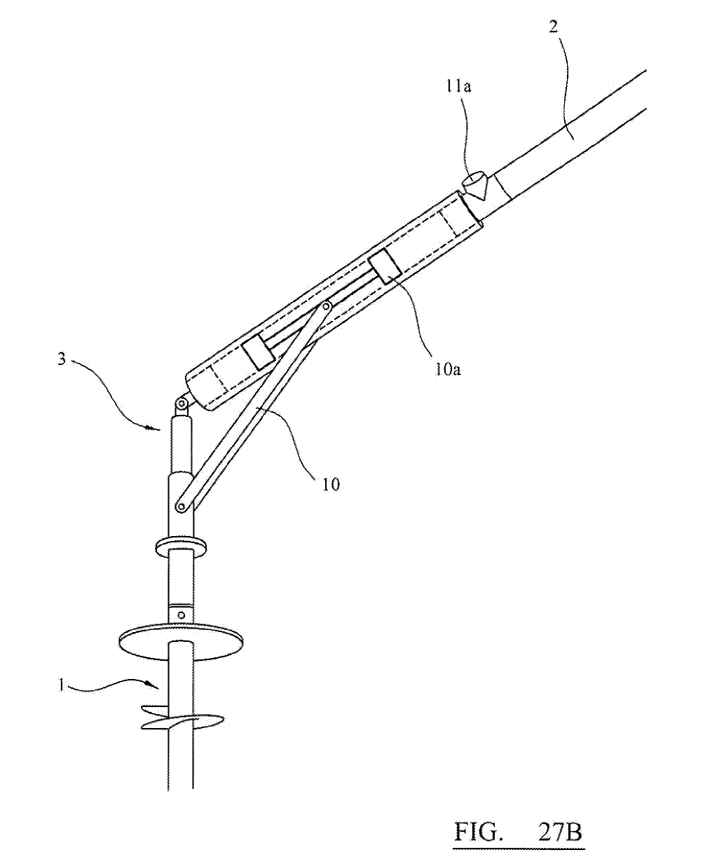

FIGS. 27a and 27b depict an example of an energy harnessing system comprising a mooring device according to the first aspect of the invention, a float (B), a pump (9) having a piston chamber (9a) and a piston (10) having a piston head (10a) mounted in the piston chamber. The mooring device comprises a pile (1) configured to be embedded in the floor (F), an arm (2), a joint (3) and joint locking means (not shown). A first end of the arm is coupled to the pile via the joint. A second end of the arm is configured to be coupled to the float using engaging means (2d) so that the float is moored near the surface of the moving body of water (W). The joint allows the float and arm move under the action of the moving body of water. The joint is configured to permit rotation of the float and arm in a vertical plane relative to the pile. If the body of water is moving due to tide and/or wave motion, the joint allows the float and arm to reciprocally rotate in a vertical plane. The piston chamber is formed within the arm and it is arranged in fluid communication with a first conduit with a two-way valve (11a) and a second conduit with a two-way valve (not shown). The piston chamber is configured to be moved relative to the piston as the float and arm rotate in the vertical plane. The pump may be a single action pump where the pump is configured to pump fluid through only one conduit. However, in this embodiment, the pump is a double action pump that can be driven to pump fluid through both conduits during the upward and downward motion of the float and arm. As the float and arm rotate downwardly in the vertical plane the piston chamber moves downwardly relative to the piston head such that fluid is drawn into the pump through conduit 11b and expelled from the pump through conduit 11a. As the float and arm rotate upwardly in the vertical plane head the piston chamber moves upwardly relative to the piston head such that fluid is drawn in through conduit 11a and expelled through conduit 11b. Hence, the pump can be reciprocately driven as a result of the tide and/or wave motion of the body of water.

In a working example of an energy harnessing system comprising a piston pump to harness energy from a body of moving water, where the mass of the float is 100 Kg, acceleration due to gravity is approximately 10 m/s² the differential height of the arm and float during tidal and/or wave motion is approximately 1 m

Work done by body of water in moving the float through a vertical height of 1 m

$$= Weight of float \times Distance = 10 kn \times 1 m = 10 kJ$$

If the float undergoes a reciprocating cycle every 6 seconds (10 per minute, 600 per hour) and the pump is double acting then the work done by the body of water over an hour

$$\begin{matrix} = Work done by body of water \times frequency \\ of reciprocating cycle \times number of piston heads \\ = 10 KJ \times 600 \times 2 \\ = 12000 kJ\end{matrix}$$

Since 1 kWh is equivalent to 3600 kJ, then the energy generated by the pump over an hour

=3.33 kWh

If the piston chamber diameter is approximately 0.1 m and the stroke length of the piston chamber is approximately 0.5 m then the volume of fluid pumped by the pump every hour

$$\begin{matrix} = Area of piston chamber \times stroke length \\ of piston chamber \times frequency of reciprocating cycle \\ every hour \times number of piston heads \\ = 3.14 \times 0.05 \times 0.05 \times 0.5 \times 600 \times 2 \\ = 4.71 {m}^{3}\end{matrix}$$

If the pump is configured to drive an hydroelectric transducer that is 30% efficient then the amount of electricity generated by the transducer will be

$$\begin{matrix} = energy generated by the pump \times \\ efficiency of the transducer \\ = 3.33 kWh \times 30 \% \\ = 1 kWh\end{matrix}$$

Whilst endeavouring in the foregoing specification to draw attention to those features of the invention believed to be of particular importance, it should be understood that the applicant claims protection in respect of any patentable feature or combination of features referred to therein, and/or shown in the drawings, whether or not particular emphasis has been placed thereon.

Throughout the description and claims of this specification, the words “comprise” and “contain”, and any variations of the words, means “including but not limited to” and is not intended to (and does not) exclude other features, elements, components, integers or steps.

Throughout the description and claims of this specification, the singular encompasses the plural unless the context requires otherwise. In particular, where the indefinite article is used, the specification is to be understood as contemplating plurality as well as singularity, unless the context requires otherwise.

Features, integers or characteristics described in conjunction with a particular aspect, embodiment or example of the invention are to be understood to be applicable to any other aspect, embodiment or example described herein unless incompatible therewith.

1. A mooring device for use in a body of water comprising:
a pile configured to be embedded in a floor supporting the body of water;
at least one arm configured to engage at least one entity;
a joint coupling the pile and the at least one arm and configured to permit rotation of the at least one arm relative to the pile; and
joint locking means configured to lock the joint.

2. A mooring device according to claim 1, wherein the pile is configured to be permanently embedded in the floor or removably embedded in the floor.

3. A mooring device according to claim 1, wherein the pile comprises a shaft having a leading end and a trailing end.

4. A mooring device according to claim 3, wherein the pile comprises a tip formed at the leading end of the shaft.

5. A mooring device according to claim 3, wherein the pile comprises a stop plate arranged on the shaft at a predetermined distance from the leading end.

6. A mooring device according to claim 1, wherein the pile comprises a screw portion and/or a wing portion.

7. A mooring device according to claim 1 wherein the entity is any article that is suitable for tethering to the mooring device.

8. A mooring device according to claim 7, wherein the entity is a vessel, a floatable body, a structure, an apparatus, a barrier, an energy absorbing device that absorbs the motion of the body of water, an energy harnessing device that is driven by the motion of the body of water and/or a further mooring device.

9. A mooring device according to claim 1, wherein the at least one arm comprises an elongate body having a first end and a second end, whereby the first end is coupled to the pile.

10. A mooring device according to claim 1, wherein the at least one arm comprises engaging means to fasten the at least one entity to the mooring device.

11. A mooring device according to claim 10, wherein the at least one arm comprises an elongate body having a first end a second end, whereby the first end is couple to the pile, wherein the engaging means is arranged at the second end of the body.

12. A mooring device according to claim 10, wherein the at least one arm comprises an elongate body having a first end a second end, whereby the first end is couple to the pile, wherein the engaging means is arranged at a location along the length of the body.

13. A mooring device according to claim 10, wherein the engaging means is configured to permanently or releasably engage the entity.

14. A mooring device according to claim 10, wherein the engaging means is configured to rigidly or freely engage the entity.

15. A mooring device according to claim 1, wherein the at least one arm is telescopic.

16. A mooring device according to claim 1, wherein the at least one arm comprises a plurality of jointed portions.

17. A mooring device according to claim 1, wherein the at least one arm is buoyant in the body of the water.

18. A mooring device according to claim 1, comprising a first arm and a second arm configured to engage at least one entity.

19. A mooring device according to claim 18, wherein the joint couples the first arm and second arm with the pile and the joint is configured to permit rotation of the first arm and second arm with respect to the pile.

20. A mooring device according to claim 18, further comprising arm locking means configured to lock the first arm and second arm together.

21. A mooring device according to claim 1, wherein the joint is configured to allow the at least one arm to be rotated so that the at least one arm can extend from the pile to a predetermined height above the floor.

22. A mooring device according to claim 21, wherein the joint is configured to allow the at least one arm to be rotated so that the height of the at least one arm can vary in accordance with the depth of the body of water.

23. A mooring device according to claim 21 or 22 wherein, when the mooring device is mounted in the body of water, the joint is configured to allow the at least one arm to be rotated in a vertical plane.

24. A mooring device according to claim 1, wherein the joint is configured to allow the at least one arm to be rotated so that the at least one arm can extend from the pile in a predetermined direction.

25. A mooring device according to claim 24 wherein the joint is configured to allow the at least one arm to be rotated so that the direction of the at least one arm can vary in accordance with the direction of flow.

26. A mooring device according to claim 24 wherein, when the mooring device is mounted in the body of water, the joint is configured to allow the at least one arm to be rotated in a horizontal plane.

27. A mooring device according to claim 1 wherein the joint comprises a multi-axle joint, a single-axle joint or a plurality of single-axle joints.

28. A mooring device according to claim 1, wherein the joint locking means comprises a plurality of complimentary engaging members, whereby the joint is locked when the complimentary engaging members engage and the joint is unlocked when at least one of the engaging members disengages from an adjacent engaging member.

29. A mooring device according to claim 28, wherein the joint locking means comprises a first engaging member and a complimentary second engaging member movable between a joint locked position where the first engaging member and second engaging member are engaged and a joint unlocked position where the first engaging member and second engaging member are spatially separated.

30. A mooring device according to claim 29, wherein the first engaging member and/or the second engaging member is movable.

31. A mooring device according to claim 28, wherein the engaging members comprise complimentary castellations and/or complimentary male and female coupling means.

32. A mooring device according to claim 28 wherein the joint locking means comprises control means for controlling the relative position and movement of the engaging means.

33. A mooring device comprising:
a pile having a leading end and a trailing end and configured to be embedded in a floor supporting the body of water;
an arm having a first end, second end and coupling means to engage an entity;
a joint coupling the trailing end of the pile and the first end of the arm and configured to permit rotation of the arm relative to the pile in at least one plane; and
joint locking means configured to lock the joint and thereby inhibit rotation of the arm relative to the plane.

34. A method of mounting a mooring device, wherein the mooring device includes a pile configured to be embedded in a floor supporting the body of water; at least one arm configured to engage at least one entity; a joint coupling the pile and the at least one arm and configured to permit rotation of the at least one arm relative to the pile; and joint locking means configured to lock the joint, the method comprising:
transporting the mooring device to a desired location;
rotating the arm with respect to the pile until the arm and pile are substantially co-axial;
activating the joint locking means to lock the joint so that the mooring device becomes a rigid structure; and
driving the mooring device into the floor supporting the body of water until the pile is embedded in the floor.

35. A method according to claim 34, wherein the mooring device is rotationally driven into the floor using driving means.

36. A method according to claim 34, further comprising:
engaging an entity to the arm; and
deactivating the joint locking means to unlock the joint so that the arm is free to rotate with respect to the pile.

37. A mooring device according to claim 1, wherein the mooring device is within a system for use in a body of water, wherein the system comprises multiple mooring devices.

38. The mooring system according to claim 37 comprising two or more mooring devices configured to be coupled together in the body of water.

39. The mooring system according to claim 37, comprising two or more mooring devices configured to be mounted in spaced relation in the body of water.

40. The mooring device according to claim 1, wherein the mooring device is to moor a floatable entity in a body of water.

41. The mooring device according to claim 40, wherein the floatable entity is a float, a vessel or any other item that is suitable for tethering to a mooring device for floatation in the body of water.

42. The mooring device according to claim 1, wherein the mooring device is used to moor at least one entity at a fixed height above a floor supporting a body of water.

43. The mooring device according to claim 1, wherein the mooring device is to moor at least one drilling apparatus in a body of water.

44. The mooring device according to claim 1, wherein the mooring device is used in a drilling system, the drilling system comprising:
at least one drilling apparatus for drilling into a floor supporting a body of water;
wherein the mooring device is for mooring the at least one drilling apparatus in the body of water.

45. The mooring device according to claim 1, wherein the mooring device is used to moor at least one energy absorbing member in a body of water.

46. A breakwater system comprising:
at least one energy absorbing member for absorbing moving water energy and impeding the flow of a moving body of water; and
at least one mooring device comprising:
a pile configured to be embedded in a floor supporting the body of water;
at least one arm configured to engage at least one entity;
a joint coupling the pile and the at least one arm and configured to permit rotation of the at least one arm relative to the pile; and
joint locking means configured to lock the joint, for mooring the at least one energy absorbing member in the body of water; whereby the at least one energy absorbing member is coupled to at least one arm of at least one mooring device; and
the joint of the at least one mooring device allows the arm and the at least one energy absorbing member to be orientated to so that the at least one energy absorbing member is able to absorb energy and impede the flow of the moving body of water.

47. The breakwater system according to claim 46, wherein the at least one energy absorbing member is a floatable member.

48. The breakwater system according to claim 46, wherein the at least one energy absorbing member is a panel-like structure, box-like structure or triangular prism-like structure.

49. The breakwater system according to claim 46 wherein the at least one energy absorbing member is movable or substantially stationary under the action of the moving body of water and/or is deformable or substantially rigid under the action of the body of moving water.

50. The mooring device according to claim 1, wherein the mooring device is used to moor at least one aquatic barrier in a body of water so as to form an aquatic wall.

51. An aquatic wall comprising:
at least one aquatic barrier; and
at least one mooring device for mooring the at least one aquatic barrier in a body of water, the mooring device comprising:
a pile configured to be embedded in a floor supporting the body of water;
at least one arm configured to engage at least one entity;
a joint coupling the pile and the at least one arm and configured to permit rotation of the at least one arm relative to the pile; and
joint locking means configured to lock the joint.

52. The mooring device according to claim 1, wherein the mooring device is used to moor a cable/pipe laying device in a body of water.

53. An underwater cable/pipe laying system comprising:
at least one underwater laying device for laying cable and/or pipe along a floor supporting a body of water; and
at least one mooring device for mooring the at least one underwater laying device in the body of water, the mooring device comprising:
a pile configured to be embedded in a floor supporting the body of water;
at least one arm configured to engage at least one entity;
a joint coupling the pile and the at least one arm and configured to permit rotation of the at least one arm relative to the pile; and
joint locking means configured to lock the joint.

54. The mooring device according to claim 1, wherein the mooring device is used to moor at least one energy harnessing device in a body of water.

55. The mooring device of claim 1, wherein the mooring device is used in an energy harnessing system that includes:
at least one energy harnessing device; and
the mooring device is for mooring the at least one energy harnessing device in a moving body of water.

56. The energy harnessing system according to claim 55, wherein the energy harnessing device comprises a rotatable actuator, a linear actuator, a hydraulic actuator, an electromagnetic actuator or a deformable pumping body driven under the action of the moving body of water.

57. The energy harnessing system according to claim 56, further comprising a transducer for converting the energy harnessed by the energy harvesting device into another form of energy.

58. The energy harnessing system according to claim 55, further comprising a floatable body coupled to the at least one arm of the at least one mooring device.

59. The energy harnessing system according to claim 55, further comprising at least one guide member for guiding the moving body of water towards the energy harnessing device.

60. An energy harnessing system comprising:
a mooring device having a pile, an arm, a joint coupling the pile and arm and permitting rotation of the arm relative to the pile and a joint locking means for preventing rotation of the arm relative to the pile;
a turbine coupled to the arm;
wherein in use, the pile is embedded in a floor of a body of moving water, the joint orientates the arm so that the turbine is arranged in the body of moving water and the turbine is driven by the motion of the body of water.

61. An energy harnessing system comprising:
a mooring device having a pile, an arm, a joint coupling the pile and arm and permitting rotation of the arm relative to the pile and a joint locking means for preventing rotation of the arm relative to the pile;
a deformable pumping chamber with at least one fluid conduit coupled to the arm;
a hydroelectric transducer arranged adjacent the at least one fluid conduit;
wherein in use, the pile is embedded in a floor of the body of moving water, the arm reciprocately drives the deformable chamber between an expanded condition and a contracted condition as a result of the motion of the body of water such that fluid is pumped into and out of the deformable chamber via the at least one fluid conduit and the hydroelectric transducer generates electricity under the flow of fluid into and/or out of the deformable chamber.

62. An energy harnessing system comprising:
a mooring device having a pile, an arm, a joint coupling the pile and arm and permitting rotation of the arm relative to the pile and a joint locking means for preventing rotation of the arm relative to the pile;
a flywheel coupled to the arm;
wherein in use, the pile is embedded in a floor of a body of water and the flywheel is driven by the reciprocating action of the arm that results from the motion of the body of water acting on the arm.

63. An energy harnessing system comprising:
a mooring device having a pile, an arm, a joint coupling the pile and arm and permitting rotation of the arm relative to the pile and a joint locking means for preventing rotation of the arm relative to the pile;
a rack and pinion coupled to the arm;
wherein in use, the pile is embedded in a floor of a body of water and the pinion is driven along the rack by the reciprocating action of the arm that results from the motion of the body of water acting on the arm.

64. An energy harnessing system comprising:
a mooring device having a pile, an arm, a joint coupling the pile and arm and permitting rotation of the arm relative to the pile and a joint locking means for preventing rotation of the arm relative to the pile;
a pump having a piston chamber defined by the arm and arranged in fluid communication with at least one fluid conduit and a piston with piston head which is movably received within the piston chamber;
wherein in use, the pile is embedded in a floor of a body of water, the joint orientates the arm so that the arm extends to a height in the body of water in the direction of flow and the arm reciprocately drives the piston head within the piston chamber as a result of the motion of the body of water acting on the arm such that fluid is pump into and out of the chamber via the at least one fluid conduit.

65-80. (canceled)
